(19) United States
(12) Patent Application Publication
(10) Pub. No.: US 2020/0369961 A1
(43) Pub. Date: Nov. 26, 2020

(54) OPTICAL FILM, POLARIZING PLATE, AND IMAGE DISPLAY DEVICE

(71) Applicant: FUJIFILM Corporation, Tokyo (JP)

(72) Inventors: Ayako MURAMATSU, Kanagawa (JP); Ryo SATAKE, Kanagawa (JP); Mayumi NOJIRI, Kanagawa (JP); Aiko YOSHIDA, Kanagawa (JP); Keita TAKAHASHI, Kanagawa (JP); Toshikazu SUMI, Kanagawa (JP)

(73) Assignee: FUJIFILM Corporation, Tokyo (JP)

(21) Appl. No.: 16/991,209

(22) Filed: Aug. 12, 2020

Related U.S. Application Data
(63) Continuation of application No. PCT/JP2019/005285, filed on Feb. 14, 2019.

(30) Foreign Application Priority Data
Feb. 14, 2018 (JP) 2018-023822

(51) Int. Cl. C09K 19/38; C09K 19/56; G02B 5/30

(52) U.S. Cl. CPC C09K 19/3861; C09K 2019/0448; G02B 5/3016; C09K 19/56

(57) ABSTRACT

Provided is an optical film having an excellent film contrast and improved moisture-heat resistance, a polarizing plate, and an image display device. The optical film has an optically anisotropic film obtained by polymerizing a polymerizable liquid crystal composition, and a photo-alignment film, in which the polymerizable liquid crystal composition contains a polymerizable liquid crystal compound represented by Formula (1): L¹-SP¹-E¹-Cy²-Cy¹-D¹-Ar¹-D²-Cy³-Cy⁴-E²-SP²-L² and the optically anisotropic film satisfies Formula (I): Re(450)/Re(550)<1 or Formula (II): Rth(450)/Rth(550)<1 and exhibits a diffraction peak derived from a periodic structure in X-ray diffraction measurement.

### CROSS-REFERENCE TO RELATED APPLICATIONS

This application is a Continuation of PCT International Application No. PCT/JP2019/005285 filed on Feb. 14, 2019, which claims priority under 35 U.S.C. § 119(a) to Japanese Patent Application No. 2018-023822 filed on Feb. 14, 2018. The above application is hereby expressly incorporated by reference, in its entirety, into the present application.

### BACKGROUND OF THE INVENTION

### 1. Field of the Invention

The present invention relates to an optical film, a polarizing plate, and an image display device.

### 2. Description of the Related Art

A polymerizable compound exhibiting reciprocal wavelength dispersibility enables, for example, accurate conversion of light ray wavelengths over a wide wavelength range and reduction in the thickness of a phase difference film due to its high refractive index, and therefore, it has been actively studied.

Furthermore, for the polymerizable compound exhibiting reciprocal wavelength dispersibility, T-type molecular design guidelines have generally been adapted, and thus, it has been required to decrease the wavelength of the major axis of the molecule and increase the wavelength of the minor axis positioned at the center of the molecule.

In this regard, it is known that a cycloalkylene skeleton having no absorption wavelength is used for connection between a skeleton of the minor axis positioned at the center of the molecule (hereinafter also referred to as a “reciprocal wavelength dispersion expressing part”) and the major axis of the molecule (see, for example, JP2010-031223A, WO2014/010325A, and JP2016-081035A).

### SUMMARY OF THE INVENTION

In recent years, due to a demand for pixel miniaturization or a demand for a high dynamic range (HDR) having a panel contrast ratio larger than that in the related art, characteristics that a display contrast ratio is not lowered (hereinafter also referred to as an “excellent in film contrast”) have been required in a case where a phase difference films (optically anisotropic films) are mounted on various display devices.

In addition, as various display devices are developed in diversified applications, it has been required that phase difference films (optical films) should withstand uses in severer moisture-heat environments such as on-vehicle applications and long-term outdoor uses.

Therefore, an object of the present invention is to provide an optical film having an excellent film contrast and improved moisture-heat resistance, a polarizing plate, and an image display device.

The present inventors have conducted intensive studies to accomplish the object, and as a result, they have found that an polymerizable liquid crystal composition in which a polymerizable liquid crystal compound having a group satisfying a predetermined condition in a reciprocal wavelength dispersion expressing part is blended is used to form an optically anisotropic film on a photo-alignment film, and the optically anisotropic, film exhibiting a diffraction peak derived from a predetermined periodic structure has excellent film contrast and improved moisture-heat resistance, thereby completing the present invention.

That is, the present inventors have found that the object can be accomplished by the following configurations.

[1] An optical film comprising:
an optically anisotropic film obtained by polymerizing a polymerizable liquid crystal composition; and
a photo-alignment film,
in which the polymerizable liquid crystal composition contains a polymerizable liquid crystal compound represented by Formula (1) which will be described later, and
the optically anisotropic film satisfies Formula (I) or (II) which will be described later and exhibits a diffraction peak derived from a periodic structure in X-ray diffraction measurement.

[2] The optical film as described in [1],
in which the polymerizable liquid crystal composition further contains a polymerizable liquid crystal compound represented by Formula (2).

[3] The optical film as described in [1] or [2],
in which Ar¹ in Formula (1) which will he described later is represented by Formula (Ar-2) which will be described later.

[4] The optical film as described in any one of [1] to [3],
in which the liquid crystal compound contained in the polymerizable liquid crystal composition has an I/O value of 0.51 or less as a weighted average value.

[5] The optical film as described in any one of [1] to [4],
in which the polymerizable liquid crystal composition further contains a polymerizable compound not corresponding to any of the polymerizable liquid crystal compound represented by Formula (1) as described in [1] and the polymerizable liquid crystal compound represented by Formula (2) as described in [2], and having two or more polymerizable groups.

[6] The optical film as described in any one of [1] to [5],
in which the polymerizable liquid crystal composition contains a polymerization initiator.

[7] The optical film as described in [6],
in which the polymerization initiator is an oxime-type polymerization initiator.

[8] A polarizing plate comprising:
the optical film as described in any one of [1] to [7]; and
a polarizer.

[9] An image display device comprising:
the optical film as described in any one of [1] to [7] or the polarizing plate as described in [8].

According to the present invention, the present invention can provide an optically anisotropic film having an excellent film contrast and improved moisture-heat resistance, a polarizing plate, and an image display device.

### BRIEF DESCRIPTION OF THE DRAWINGS

FIG. 1A is a schematic cross-sectional view showing an example of an optical film of an embodiment of the present invention.

FIG. 1B is a schematic cross-sectional view showing an example of the optical film of the embodiment of the present invention.

FIG. 1C is a schematic cross-sectional view showing an example of the optical film of the embodiment of the present invention.

### DESCRIPTION OF THE PREFERRED EMBODIMENTS

Hereinafter, the present invention will be described in detail.

Descriptions on the constitutional requirements which will be described later are made based on representative embodiments of the present invention in some cases, but it should not be construed that the present invention is limited to such embodiments.

Furthermore, in the present specification, a numerical value range expressed using “to” means a range that includes the preceding and succeeding numerical values of “to” as the lower limit value and the upper limit value, respectively.

In addition, in the present specification, the bonding direction of a divalent group (for example, —O—CO—) as noted is not particularly limited unless the bonding position is specified, and for example, in a case where D¹ in Formula (1) which will be described later is —CO—O—, D¹ may be either *1—CO—O—*2 or *1-O—CO—*2, in which *1 represents a bonding position to the Ar¹ side and *2 represents a bonding position to the Cy¹ side.

In addition, in the present specification, angles (for example, angles of “90°”) and relationships thereof (for example, “orthogonal”, “parallel”, and “intersecting at 45°”) include error ranges accepted in the technical field to which the present invention belongs. For example, the angle means an angle in a range of less than ±10° of a rigorous angle, and the error from the rigorous angle is preferably 5° or less, and more preferably 3° or less.

[Optical Film]

The optical film of the embodiment of the present invention is an optical film having an optically anisotropic film obtained by polymerizing a polymerizable liquid crystal composition and a photo-alignment film.

Moreover, in the present invention, the polymerizable liquid crystal composition contains a polymerizable liquid crystal compound represented by Formula (1).

Furthermore, in the present invention, the optically anisotropic film satisfies Formula (I) or (II) which will be described later, and exhibits a diffraction peak derived from a periodic structure in X-ray diffraction measurement.

In the present invention, a polymerizable liquid crystal composition in which a polymerizable liquid crystal compound represented by Formula (1) which will be described later (hereinafter also simply referred to as a “polymerizable liquid crystal compound (1)”) is blended is used to form an optically anisotropic film on a photo-alignment film, as described above, and the optically anisotropic film exhibiting a diffraction peak derived from a predetermined periodic structure has excellent film contrast and improved moisture-heat resistance.

A reason therefor is not specifically clear, but is presumed to be as follows by the present inventors.

First, it is considered that since the aromatic ring (Ar¹) constituting the reciprocal wavelength expressing part in the polymerizable liquid crystal compound (1) has a group having a small van der. Waals volume, as shown in Formula (1) which will be described later, a smectic phase which is a highly ordered phase is easily expressed due to a π-π interaction between the aromatic rings.

Further, it is considered that in a case where the optically anisotropic film is in the smectic phase, the fluctuation of the alignment can be suppressed to a small level, and thus, the film contrast is improved.

Moreover, it is considered that by controlling the alignment of the optically anisotropic film using the photo-alignment layer, incorporation of foreign matters (for example, rubbing dust in a case where a rubbing alignment is performed) is suppressed, and as a result, the film contrast is improved.

In addition, it is presumed that since the polymerizable liquid crystal compound (1) has a partial structure in which two 1,4-cyclohexylene groups are linked by a single bond on the major axis of the molecule, the compound becomes hydrophobic and the hydrolysis of the optically anisotropic film is reduced, and as a result, the moisture-heat resistance is improved.

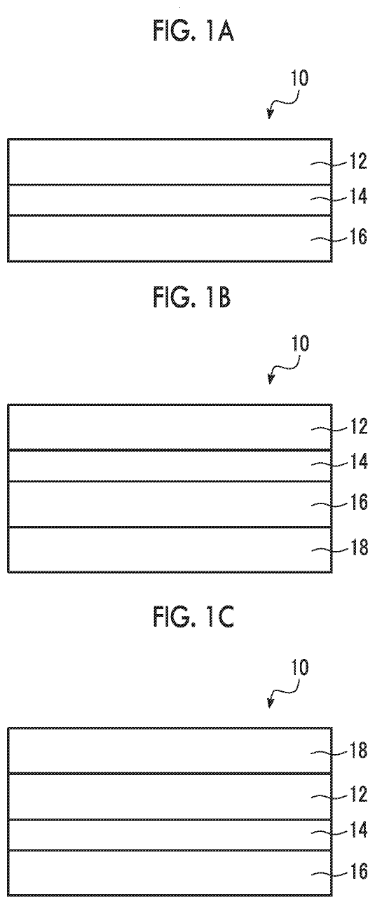

FIG. 1A, FIG. 1B, and FIG. 1C (these drawings are hereinafter simply referred to as “FIG. 1” unless it is necessary that they are particularly distinguished from each other) are each a schematic cross-sectional view showing an example of the optical film of the embodiment of the present invention.

Furthermore, FIG. 1 is a schematic view, and the thicknesses relationship, the positional relationship, and the like of the respective layers are not necessarily consistent with actual ones, and any of the support and the hard coat layer shown in FIG. 1 are optional constitutional members.

An optical film 10 shown in FIG. 1 has a support 16, a photo-alignment film 14, and an optically anisotropic film 12 in this order.

In addition, the optical film 10 may have a hard coat layer 18 on the side of the support 16 opposite to the side on which the photo-alignment film 14 is provided as shown in FIG. 1B, and may have the hard coat layer 18 on the side of the optically anisotropic film 12 opposite to the side on which the photo-alignment film 14 is provided as shown in FIG. 1C.

Hereinafter, various members used for the optical film of the embodiment of the present invention will be described in detail.

[Optically Anisotropic Film]

The optically anisotropic film included in the optical film of the embodiment of the present invention is an optically anisotropic film obtained by polymerizing a polymerizable liquid crystal composition (hereinafter formally referred to as a “polymerizable liquid crystal composition of the embodiment of the present invention”) which the polymerizable liquid crystal compound (I) is blended as described above.

Hereinafter, the respective components of the polymerizable liquid crystal composition of the embodiment of the present invention will be described in detail.

<Polymerizable Liquid Crystal Compound (1)>

The polymerizable liquid crystal compound (1) contained in the polymerizable liquid crystal composition of the embodiment of the present invention is a polymerizable liquid crystal compound represented by Formula (1).

L¹-SP¹-E¹-Cy²-Cy¹-D¹-Ar¹-D²-Cy³-Cy⁴-E²-SP²-L² (1)

In addition, in Formula (I), D¹, D², E¹, and E² each independently represent a single bond, —CO—O—, —C(═S)O—, —CR¹R²—, —CR¹R²—CR³R⁴—, —O—CR¹R²—, —CR¹R²—O—CR³R⁴—, —CO—O—CR¹R²—, —O—CO—CR¹R²—, —CR¹R²—O—CO—CR³R⁴—, —CR¹R²—CO—O—CR³R⁴—, —NR¹—CR²R³—, or —CO—NR¹—. R¹, R², R³, and R⁴ each independently represent a hydrogen atom, a fluorine atom, or an alkyl group having 1 to 4 carbon atoms.

Furthermore, in Formula (1), Cy¹, Cy², Cy³, and Cy⁴ each independently represent a 1,4-cyclohexylene group which may have a substituent.

Incidentally, in Formula (1), SP¹ and SP² each independently represent a single bond, a linear or branched alkylene group having 1 to 12 carbon atoms, or a divalent linking group in which one or more of —CH₂—'s constituting the linear or branched alkylene group having 1 to 12 carbon atoms are substituted with —O—, —S—, —NH—, —N(Q)-, or —CO—, and Q represents a substituent.

Furthermore, in Formula (1), L¹ and L² each independently represent a monovalent organic group, and at least one of L¹ or L² represents a polymerizable group.

In Formula (1), Cy¹, Cy², Cy³, and Cy⁴ represent a 1,4-cyclohexylene group, and in the present invention, a trans-1,4-cyclohexylene group is preferable.

Suitable examples of the linear or branched alkylene group having 1 to 12 carbon atoms represented by each of SP¹ and SP² in Formula (1) include a methylene group, an ethylene group, a propylene group, a butylene group, a pentylene group, a hexylene group, a methylhexylene group, and a heptylene group. Incidentally, SP¹ and SP² may be a divalent linking group in which one or more of —CH₂—'s constituting the linear or branched alkylene group having 1 to 12 carbon atoms are substituted with —O—, —S—, —NH—, —N(Q)-, or —CO—, as described above, and examples of the substituent represented by Q include the same ones as the substituents which may be contained in Y¹ in Formula (Ar-1).

In Formula (1), examples of the monovalent organic group represented by each of L¹ and L² include an alkyl group, an aryl group, and a heteroaryl group. The alkyl group may be linear, branched, or cyclic, but is preferably linear. The number of carbon atoms of the alkyl group is preferably 1 to 30, more preferably 1 to 20, and still more preferably 1 to 10. Further, the aryl group may be a monocycle or a polycycle, but is preferably the monocycle. The number of carbon atoms of the aryl group is preferably 6 to 25, and more preferably 6 to 10. Further, the heteroaryl group may be a monocycle or a polycycle. The number of heteroatoms constituting the heteroaryl group is preferably 1 to 3. The heteroatoms constituting the heteroaryl group is preferably a nitrogen atom, a sulfur atom, or an oxygen atom. The number of carbon atoms of the heteroaryl group is preferably 6 to 18, and more preferably 6 to 12. In addition, the alkyl group, the aryl group, and the heteroaryl group may be unsubstituted or have a substituent. Examples of the substituent include the same ones as the substituents which may be contained in Y¹ in Formula (Ar-1) which will be described later.

In Formula (1), the polymerizable group represented by at least one of L¹ or L² is not particularly limited, but is preferably a polymerizable group which is radically polymerizable or cationically polymerizable.

A generally known radically polymerizable group can be used as the radically polymerizable group, and suitable examples thereof include an acryloyl group and a methacryloyl group. In this case, it is known that the acryloyl group generally has a high polymerization rate, and from the viewpoint of improvement of productivity, the acryloyl group is preferable but the methacryloyl group can also be used in the same manner as the polymerizable group.

A generally known cationically polymerizable group can be used as the cationically polymerizable group, and specific examples thereof include an alicyclic ether group, a cyclic acetal group, a cyclic lactone group, a cyclic thioether group, a spiroorthoester group, and a vinyloxy group. Among those, the alicyclic ether group or the vinyloxy group is preferable, and an epoxy group, an oxetanyl group, or the vinyloxy group is particularly preferable.

Particularly preferred examples of the polymerizable group include the following groups.

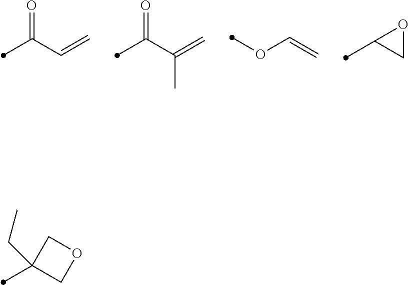

In Formula (1), for a reason that the moisture-heat resistance is improved, L₁ and L2 in Formula (1) are each preferably a polymerizable group, and are preferably an acryloyl group or a methacryloyl group.

On the other hand, in Formula (1), Ar¹ represents an aromatic ring which is selected from the group consisting of groups represented by Formulae (Ar-1) to (Ar-4) and satisfies any one of the following conditions 1 to 3.

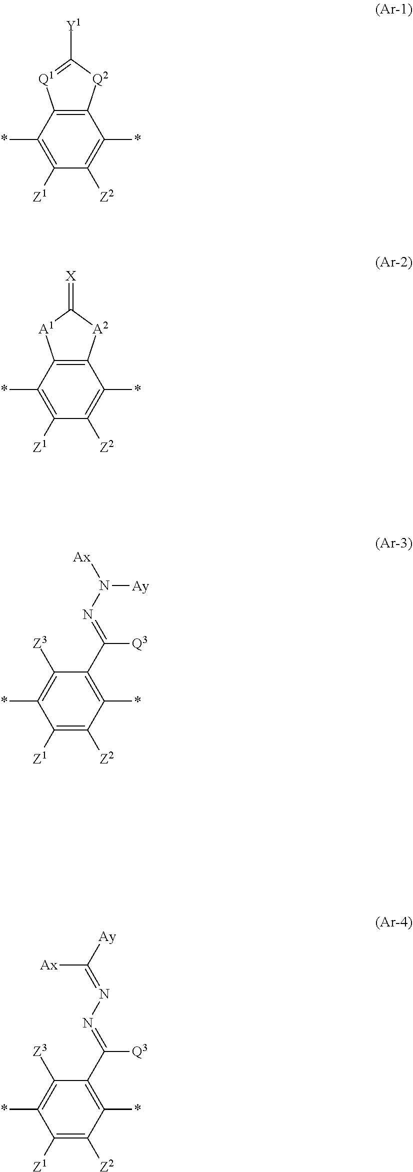

Here, in Formula (Ar-1), Q¹ represents N or CH, Q² represents —S—, —O—, or —N(R⁵)—, R⁵ represents a hydrogen atom or an alkyl group having 1 to 6 carbon atoms, and Y¹ represents an aromatic hydrocarbon group having 6 to 12 carbon atoms or an aromatic heterocyclic group having 3 to 12 carbon atoms, each of which may have a substituent.

Specific examples of the alkyl group having 1 to 6 carbon atoms represented by R⁵ include a methyl group, an ethyl group, a propyl group, an isopropyl group, an n-butyl group, an isobutyl group, a sec-butyl group, a tert-butyl group, an n-pentyl group, and an n-hexyl group.

Examples of the aromatic hydrocarbon group having 6 to 12 carbon atoms represented by Y¹ include aryl groups such as a phenyl group, a 2,6-diethylphenyl group, and a naphthyl group.

Examples of the aromatic heterocyclic group having 3 to 12 carbon atoms represented by Y¹ include heteroaryl groups such as a thienyl group, a thiazolyl group, a furyl group, and a pyridyl group.

Furthermore, examples of the substituent which may be contained in Y¹ include an alkyl group, an alkoxy group, and a halogen atom.

As the alkyl group, for example, a linear, branched, or cyclic alkyl group having 1 to 18 carbon atoms is preferable, an alkyl group having 1 to 8 carbon atoms (for example, a methyl group, an ethyl group, a propyl group, an isopropyl group, an n-butyl group, an isobutyl group, a sec-butyl group, a t-butyl group, and a cyclohexyl group) is more preferable, an alkyl group having 1 to 4 carbon atoms is still more preferable, and the methyl group or the ethyl group is particularly preferable.

As the alkoxy group, for example, an alkoxy group having 1 to 18 carbon atoms is preferable, an alkoxy group having 1 to 8 carbon atoms (for example, a methoxy group, an ethoxy group, an n-butoxy group, and a methoxy ethoxy group) is more preferable, an alkoxy group having 1 to 4 carbon atoms is still more preferable, and the methoxy group or the ethoxy group is particularly preferable.

Examples of the halogen atom include a fluorine atom, a chlorine atom, a bromine atom, and an iodine atom, and among these, the fluorine atom or the chlorine atom is preferable.

In addition, in Formulae (Ar-1) to (Ar-4), Z¹, Z², and Z³ each independently represent a hydrogen atom, a monovalent aliphatic hydrocarbon group having 1 to 20 carbon atoms, a monovalent alicyclic hydrocarbon group having 3 to 20 carbon atoms, a monovalent aromatic hydrocarbon group having 6 to 20 carbon atoms, a halogen atom, a cyano group, a nitro group, —OR⁶, —NR⁷R⁸, or —SR⁹, R⁶ to R⁹ each independently represent a hydrogen atom or an alkyl group having 1 to 6 carbon atoms, and Z¹ and Z² may be bonded to each other to form an aromatic ring.

As the monovalent aliphatic hydrocarbon group having 1 to 20 carbon atoms, an alkyl group having 1 to 15 carbon atoms is preferable, an alkyl group having 1 to 8 carbon atoms is more preferable, and specifically, a methyl group (Me), an ethyl group, an isopropyl group, a tert-pentyl group (1,1-dimethylpropyl group), a tert-butyl group (tBu), or a 1,1-dimethyl-3,3-dimethyl-butyl group is still more preferable, and the methyl group, the ethyl group, and the tert-butyl group are particularly preferable.

Examples of the monovalent alicyclic hydrocarbon group having 3 to 20 carbon atoms include monocyclic saturated hydrocarbon groups such as a cyclopropyl group, a cyclobutyl group, a cyclopentyl group, a cyclohexyl group, a cycloheptyl group, a cyclooctyl group, a cyclodecyl group, a methylcyclohexyl group, and an ethylcyclohexyl group; monocyclic unsaturated hydrocarbon groups such as a cyclobutenyl group, a cyclopentenyl group, a cyclohexenyl group, a cycloheptenyl group, a cyclooctenyl group, a cyclodecenyl group, a cyclopentadienyl group, a cyclohexadienyl group, a cyclooctadienyl group, and a cyclodecadiene; and polycyclic saturated hydrocarbon groups such as a bicyclo[2.2.1]heptyl group, a bicyclo[2.2.2]octyl group, a tricyclo[5.2.1.0^{2,6}]decyl group, a tricyclo[3.3.1.1^{3,7}]decyl group, a tetracyclo[6.2.1.1^{3,6}.0^{2,7}]dodecyl group, and an adamantyl group.

Specific examples of the monovalent aromatic hydrocarbon group having 6 to 20 carbon atoms include a phenyl group, a 2,6-diethylphenyl group, a naphthyl group, and a biphenyl group, and an aryl group having 6 to 12 carbon atoms (particularly a phenyl group) is preferable.

Examples of the halogen atom include a fluorine atom, a chlorine atom, a bromine atom, and an iodine atom, and among these, the fluorine atom, the chlorine atom, or the bromine atom is preferable.

On the other hand, specific examples of the alkyl group having 1 to 6 carbon atoms represented by each of R⁶ to R⁹ include a methyl group, an ethyl group, a propyl group, an isopropyl group, an n-butyl group, an isobutyl group, a sec-butyl group, a tert-butyl group, an n-pentyl group, and an n-hexyl group.

In addition, in Formula (Ar-2), A¹ and A² each independently represent a group selected from the group consisting of —O—, —N(R¹⁰)—, —S—, and —CO—, where R¹⁰ represents a hydrogen atom or a substituent.

Examples of the substituent represented by R¹⁰ include the same ones as the substituents which may be contained in in Formula (Ar-1).

Furthermore, in Formula (Ar-2), X represents a hydrogen atom or a non-metal atom of Groups XIV to XVI to which a substituent may be bonded.

Moreover, examples of the non-metal atom of Groups XIV to XVI represented by X include an oxygen atom, a sulfur atom, a nitrogen atom having a substituent, and a carbon atom having a substituent, and specific examples of the substituent include an alkyl group, an alkoxy group, an alkyl-substituted alkoxy group, a cyclic alkyl group, an aryl group (for example, a phenyl group and a naphthyl group), a cyano group, an amino group, a nitro group, an alkylearbonyl group, a sulfo group, and a hydroxyl group.

Moreover, in Formulae (Ar-3) and (Ar-4), Ax represents an organic group having 2 to 30 carbon atoms, which has at least one aromatic ring selected from the group consisting of an aromatic hydrocarbon ring and an aromatic. heterocyclic ring.

Furthermore, in Formulae (Ar-3) and (Ar-4), Ay represents a hydrogen atom, an alkyl group having 1 to 12 carbon atoms, which may have a substituent, or an organic group having 2 to 30 carbon atoms, which has at least one aromatic ring selected from the group consisting of an aromatic hydrocarbon ring and an aromatic heterocyclic ring.

Here, the aromatic ring in each of Ax and Ay may have a substituent, and Ax and Ay may be bonded to each other to form a ring.

In addition, Q³ represents a hydrogen atom, or an alkyl group having 1 to 6 carbon atoms, which may have a substituent.

Examples of each of Ax and Ay include the ones described in paragraphs [0039] to of WO2014/010325A.

Incidentally, specific examples of the alkyl group having 1 to 6 carbon atoms represented by Q³ include a methyl group, an ethyl group, a propyl group, an isopropyl group, an n-butyl group, an isobutyl group, a sec-butyl group, a test-butyl group, an n-pentyl group, and an n-hexyl group, and examples of the substituent include the same ones as the substituents which may be contained in Y¹ in Formula (Ar-1).

In the present invention, Ar¹ in Formula (1) is an aromatic ring which is selected from the group consisting of groups represented by Formulae (Ar-1) to (Ar-4) as described above and satisfies any one of the following conditions 1 to 3.

Condition 1: In a case where Ar¹ is represented by Formula (Ar-1), both of Z¹ and Z² represent a group having a van der Waals volume of less than 0.3×10² Å³, and a substituent which may be contained in Y¹ represent a substituent having a van der Waals volume of less than 0.3×10² Å³.

Condition 2: In a case where Ar¹ is represented by Formula (Ar-2), both of Z¹ and Z² represent a group having a van der Waals volume of less than 0.3×10² Å³, and a substituent which may be contained in X represent a substituent having a van der Waals volume of less than 0.3×10² Å³.

Condition 3: In a case where Ar¹ is represented by Formula (Ar-3) or (Ar-4), Z¹, Z², and Z³ each represent a group having a van der Waals volume of less than 0.3×10² Å³.

In addition, in the present invention, the group defining the numerical value of the van der Waals volume also includes a hydrogen atom or a halogen atom.

Here, the “van der Waals volume” refers to a volume of an area occupied by the van der Waals sphere based on the van der Waals radii of atoms constituting a substituent, and is a value calculated using the values and the method described in the “Journal of Japanese Chemistry, extra number 122; “Structure Activity Relationship of Drugs (Guidelines for Drug Design and Study on Mechanism of Action,” pp. 134 to 136, 1979, Nankodo”. In addition, a unit of the van der Waals volume (Å³) can be converted into an SI unit with 1 Å³=10⁻³ nm³.

Examples of the group or substituent having a van der Waals volume of 0.3×10² Å³ or more include a hydrogen atom (0.06×10² Å³), —CH₃ (0.25×10² Å³), —CHO (0.27×10² Å³), and —CN (0.27×10² Å³), —OCH₃ (0.30×10² Å³), and —COOH (0.33×10² Å³). Incidentally, the numerical values in parentheses are the values of van der Waals volumes.

In the present invention, for the above-mentioned polyrnerizable liquid crystal compound (1), from the viewpoint of expanding the control range of the wavelength dispersion characteristics, Ar¹ in Formula (1) as described above is preferably a group represented by Formula (Ar-1) or (Ar-2) as described above, and more preferably the group represented by Formula (Ar-2) as described above.

Suitable examples of such a polymerizable liquid crystal compound (1) include compounds represented by Formulae (1-1) to (1-7), and specifically, the compounds which have side chain structures shown in Tables 1 and 2 below as K (side chain structure) in Formulae (1-1) to (1-7).

Furthermore, in Tables 1 and 2 below, “*” shown in the side chain structure of K represents a bonding position to an aromatic ring.

In addition, in the side chain structures shown in 1-2 in Table 1 below and 2-2 in Table 2 below, a group adjacent to each of the acryloyloxy group and the methacryloyl group represents a propylene group (a group in which a methyl group is substituted with an ethylene group), and represents a mixture of position isomers in which the positions of the methyl groups are different.

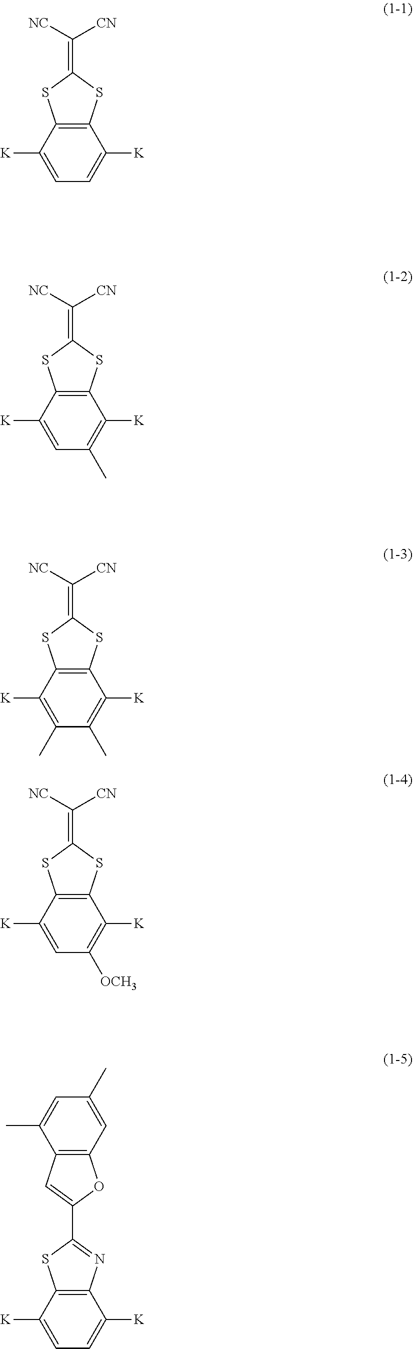

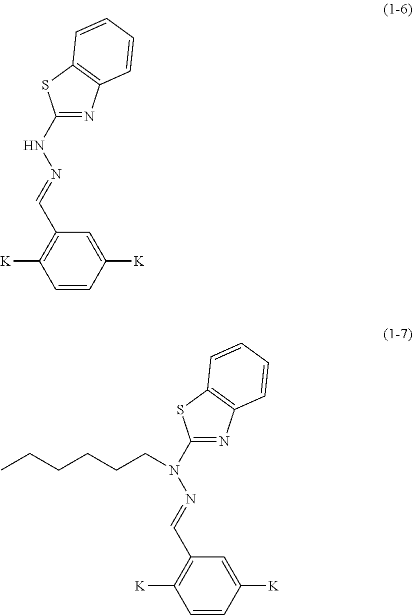

TABLE 1

| | K (Side chain structure) |
|---|---|
| 1-1 | 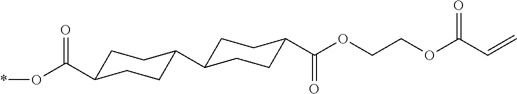 [SMILES: *OC(=O)C1CCC(C2CCC(C(=O)OCCOC(=O)C=C)CC2)CC1] |
| 1-2 | 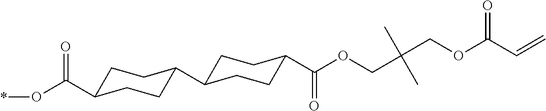 [SMILES: *OC(=O)C1CCC(C2CCC(C(=O)OCC(C)(C)COC(=O)C=C)CC2)CC1] |
| 1-3 | 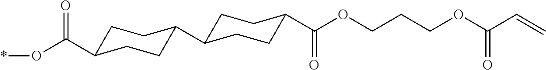 [SMILES: *OC(=O)C1CCC(C2CCC(C(=O)OCCCOC(=O)C=C)CC2)CC1] |
| 1-4 | 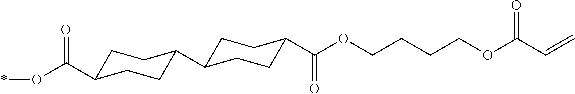 [SMILES: *OC(=O)C1CCC(C2CCC(C(=O)OCCCCOC(=O)C=C)CC2)CC1] |
| 1-5 | 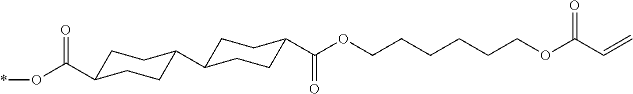 [SMILES: *OC(=O)C1CCC(C2CCC(C(=O)OCCCCCCOC(=O)C=C)CC2)CC1] |
| 1-6 | 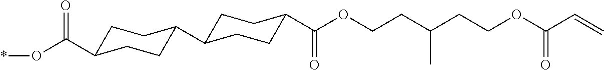 [SMILES: *OC(=O)C1CCC(C2CCC(C(=O)OCCC(C)CCOC(=O)C=C)CC2)CC1] |
| 1-7 | 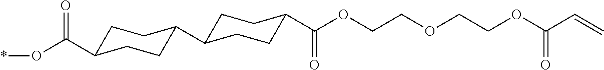 [SMILES: *OC(=O)C1CCC(C2CCC(C(=O)OCCOCCOC(=O)C=C)CC2)CC1] |
| 1-8 | 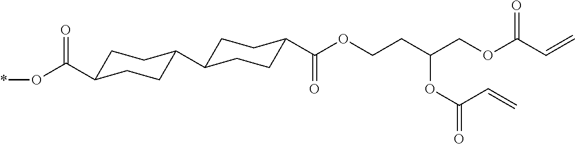 [SMILES: *OC(=O)C1CCC(C2CCC(C(=O)OCCC(COC(=O)C=C)OC(=O)C=C)CC2)CC1] |
| 1-9 | 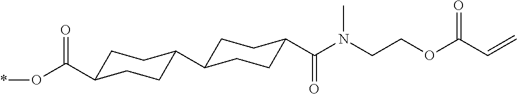 [SMILES: *OC(=O)C1CCC(C2CCC(C(=O)N(C)CCOC(=O)C=C)CC2)CC1] |
| 1-10 | 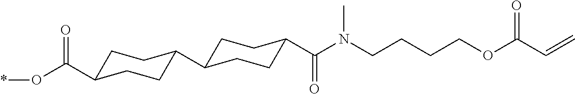 [SMILES: *OC(=O)C1CCC(C2CCC(C(=O)N(C)CCCCOC(=O)C=C)CC2)CC1] |
| 1-11 | 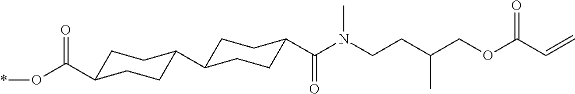 [SMILES: *OC(=O)C1CCC(C2CCC(C(=O)N(C)CCC(C)COC(=O)C=C)CC2)CC1] |
| 1-12 | 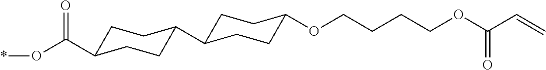 [SMILES: *OC(=O)C1CCC(C2CCC(OCCCCOC(=O)C=C)CC2)CC1] |
| 1-13 | 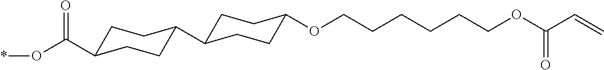 [SMILES: *OC(=O)C1CCC(C2CCC(OCCCCCCOC(=O)C=C)CC2)CC1] |
| 1-14 | 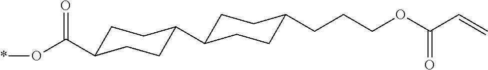 [SMILES: *OC(=O)C1CCC(C2CCC(CCCOC(=O)C=C)CC2)CC1] |

TABLE 2

| | K (Side chain structure) |
|---|---|
| 2-1 | 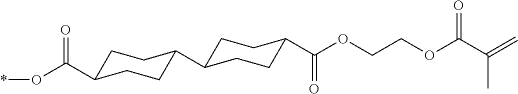 [SMILES: *OC(=O)C1CCC(C2CCC(C(=O)OCCOC(=O)C(=C)C)CC2)CC1] |
| 2-2 | 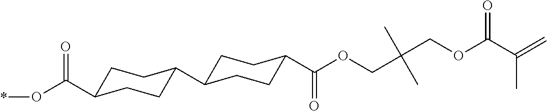 [SMILES: *OC(=O)C1CCC(C2CCC(C(=O)OCC(C)(C)COC(=O)C(=C)C)CC2)CC1] |
| 2-3 | 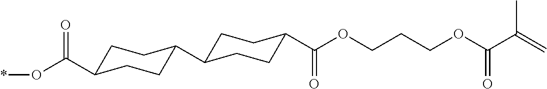 [SMILES: *OC(=O)C1CCC(C2CCC(C(=O)OCCCOC(=O)C(=C)C)CC2)CC1] |
| 2-4 | 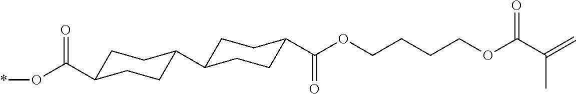 [SMILES: *OC(=O)C1CCC(C2CCC(C(=O)OCCCCOC(=O)C(=C)C)CC2)CC1] |
| 2-5 | 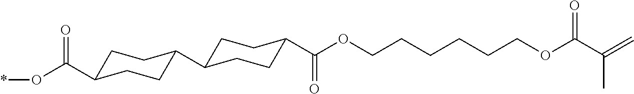 [SMILES: *OC(=O)C1CCC(C2CCC(C(=O)OCCCCCCOC(=O)C(=C)C)CC2)CC1] |
| 2-6 | 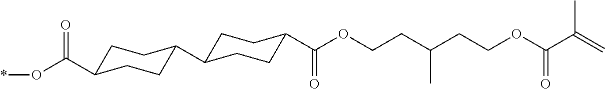 [SMILES: *OC(=O)C1CCC(C2CCC(C(=O)OCCC(C)CCOC(=O)C(=C)C)CC2)CC1] |
| 2-7 | 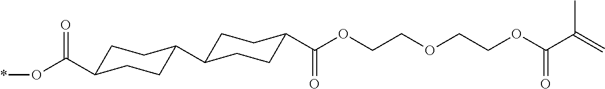 [SMILES: *OC(=O)C1CCC(C2CCC(C(=O)OCCOCCOC(=O)C(=C)C)CC2)CC1] |
| 2-8 | 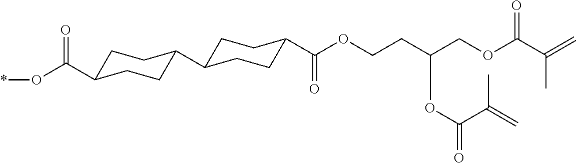 [SMILES: *OC(=O)C1CCC(C2CCC(C(=O)OCCC(COC(=O)C(=C)C)OC(=O)C(=C)C)CC2)CC1] |
| 2-9 | 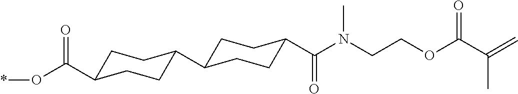 [SMILES: *OC(=O)C1CCC(C2CCC(C(=O)N(C)CCOC(=O)C(=C)C)CC2)CC1] |
| 2-10 | 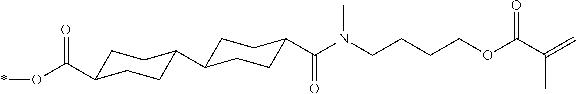 [SMILES: *OC(=O)C1CCC(C2CCC(C(=O)N(C)CCCCOC(=O)C(=C)C)CC2)CC1] |
| 2-11 | 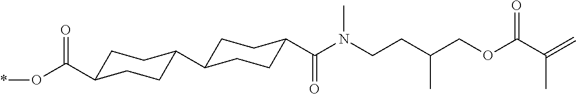 [SMILES: *OC(=O)C1CCC(C2CCC(C(=O)N(C)CCC(C)COC(=O)C(=C)C)CC2)CC1] |
| 2-12 | 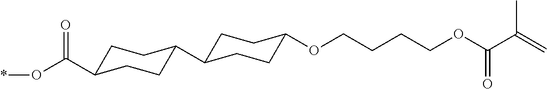 [SMILES: *OC(=O)C1CCC(C2CCC(OCCCCOC(=O)C(=C)C)CC2)CC1] |
| 2-13 | 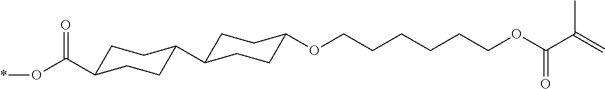 [SMILES: *OC(=O)C1CCC(C2CCC(OCCCCCCOC(=O)C(=C)C)CC2)CC1] |
| 2-14 | 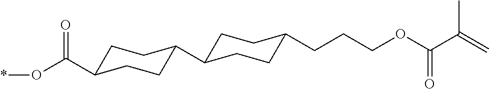 [SMILES: *OC(=O)C1CCC(C2CCC(CCCOC(=O)C(=C)C)CC2)CC1] |

<Polymerizable Liquid Crystal Compound (2)>

For a reason, that the moisture-heat resistance is improved, it is preferable that the polymerizable liquid crystal composition of the embodiment of the present invention contains the polymerizable liquid crystal compound pound represented by Formula (2) (hereinafter also simply referred to as a “polymerizable liquid crystal compound (2)”).

L¹-SP¹-E¹-Cy²-Cy¹-D¹-Ar²-D²-Cy³-Cy⁴-E²-SP²-L² (₂)

In Formula (2), D¹, D², E¹, E², E³, E⁴, G¹, G², A¹, A², SP¹, SP², L¹, L², m, and n are the same as described in Formula (1).

On the other hand, in Formula (2), Ar² represents an aromatic ring which is selected from the group consisting of groups represented by Formulae (Ar-1) to (Ar-5) and satisfies any one of the following conditions 4 to 7.

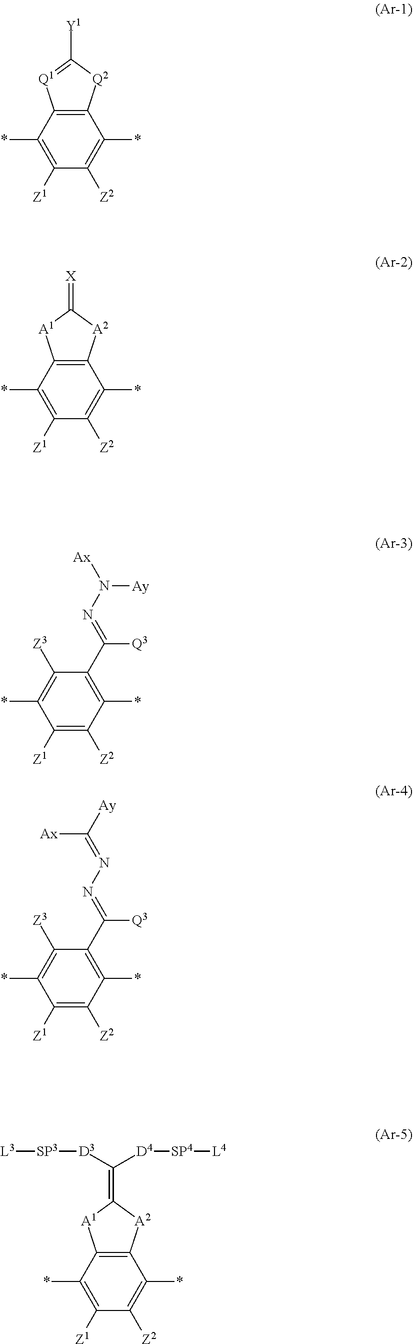

Formulae (Ar-1) to (Ar-4) of Formulae (Ar-1) to (Ar-5) are each the same as those described as Ar¹ in Formula (1).

Furthermore, in Formula (Ar-5), Z¹ and Z² are each the same as Z¹ and Z² in Formulae (Ar-1) to (Ar-5).

In Formula (Ar-5), A¹ and A² are each the same as A¹ and A² in Formula (Ar-1).

On the other hand, in Formula (Ar-5), D³ and D⁴ each independently represent a single bond, —CO—O—, —C(═S)O—, —CR¹R²—, —CR¹R²—CR³⁴—, —O—CR¹R²—, —CR¹R²—O—CR³R⁴—, —CO—O—CR¹R²—, —O—CO—CR¹R²—, —CR¹R²—O—CO—CR³R⁴—, —CR¹R²—CO—O—CR³R⁴—, —NR¹—CR²R³—, or —CO—NR¹—. R¹, R², R³, and R⁴ each independently represent a hydrogen atom, a fluorine atom, or an alkyl group having 1 to 4 carbon atoms.

Moreover, in Formula (Ar-5), SP³ and SP⁴ each independently represent a single bond, a linear or branched alkylene group having 1 to 12 carbon atoms, or a divalent linking group in which one or more of —CH₂—'s constituting the linear or branched alkylene group having 1 to 12 carbon atoms are substituted with —O—, —S—, —N(O)—, or —CO—, and Q represents a substituent. Examples of the substituent include the same ones as the substituents which may be contained in Y¹ in Formula (Ar-1).

Furthermore, in Formula (Ar-5), L³ and L⁴ each independently represent a monovalent organic group, and at least one of L³ or L⁴, or L¹ or L² in Formula (1) represents a polymerizable group.

Examples of the monovalent organic group include the same ones as the monovalent organic groups described for L¹ and L² in Formula (1).

In addition, examples of the polymerizable group include the same ones as the polymerizable groups described for L¹ and L² in Formula (1).

In the present invention, Ar² in Formula (2) is an aromatic ring which is selected from the group consisting of groups represented by Formulae (Ar-1) to (Ar-5) as described above and satisfies any one of the following conditions 4 to 7.

Condition 4: In a case where Ar² is represented by Formula (Ar-1), the substituent which may be contained in any one or more of Z¹, Z², or Y¹ represents a group having a van der Waals volume of 0.3×10² Å³ or more.

Condition 5: In a case where Ar² is represented by Formula (Ar-2), the substituent which may be contained in any one or more of Z¹, Z², or Z³ represents a group having a van der Waals volume of 0.3×10² Å³ or more.

Condition 6: In a case where Ar² is represented by Formula (Ar-3) or (Ar-4), the substituent which may be contained in any one or more of Z¹, Z², or Z³ represents a group having a van der Waals volume of 0.3×10² Å³ or more.

Condition 7: in a case where Ar² is represented by Formula (Ar-5), at least one of a group represented by -D³-SP³-L³ or a group represented by -D4-SP⁴-L⁴ represents a group having a van der Waals volume of 0.3×10² Å³ or more.

Examples of the group or substituent having a van der Waals volume of 0.3×10² Å³ or more include —C₂H₅ (0.48×10² Å³), —COOCH₃ (0.50×10² Å³), —COOC₂H₅ (0.66×10² Å³), a tert-butyl group (0.71×10² Å³), —C₃H₇ (0.71×10² Å³), —COOCH₂CH₂OC₂H₅ (1.04×10² Å³), and —COO(CH₂)₄OCH═CH₂ (1.49×10² Å³). Incidentally, the numerical values in parentheses are the values of van der Waals volumes.

In the present invention, for the above-mentioned polymerizable liquid crystal compound (2), from the viewpoint of expanding the control range of the wavelength dispersion characteristics, Ar² in Formula (2) as described above is preferably a group represented by Formula (Ar-1) or (Ar-2) as described above, and more preferably the group represented by Formula (Ar-2) as described above.

Suitable examples of such a polymerizable liquid crystal compound (2) include compounds represented by Formulae (2-1) to (2-10), and specifically, the compounds which have side chain structures shown in Tables 1 and 2 below as K (side chain structure) Formulae (2-4) to (2-10).

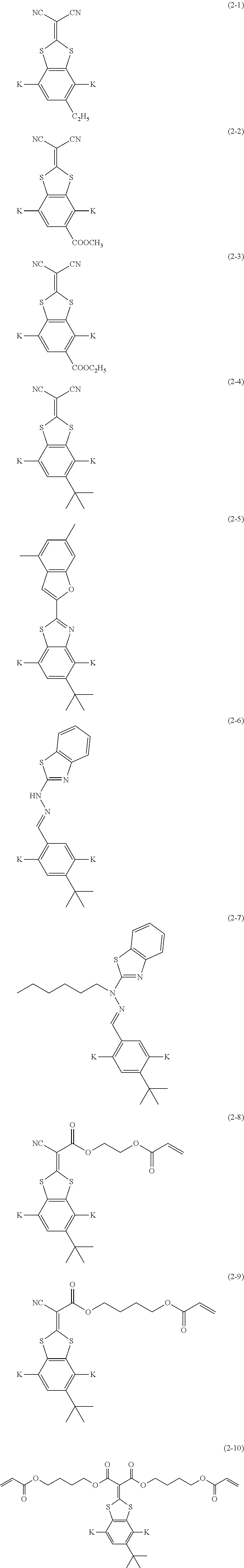

In the present invention, the content of the polymerizable liquid crystal compound (2) is preferably 30 to 300 parts by mass, more preferably 40 to 250 parts by mass, and still more preferably 50 to 200 parts by mass, with respect to 100 parts by mass of the above-mentioned polymerizable liquid crystal compound (1).

<Polymerizable Liquid Crystal Compound (3)>

The polymerizable liquid crystal composition of the embodiment of the present invention may further contain another polymerizable liquid crystal compound (3) in addition to the polymerizable liquid crystal compounds represented by Formulae (1) and (2).

As the polymerizable liquid crystal compound (3), various known polymerizable liquid crystal compounds can be used, and a polymerizable liquid crystal compound represented by Formula (3) can be suitably used.

L¹-SP¹-E¹-(G²-D²)ₙ-G¹-D¹-G³-Q (3)

In Formula (3), D¹, D², E¹, L¹, and SP¹ are each the same as those described in Formula (1).

In addition, n represents an integer of 0 to 2, and in a case where n is 2, a plurality of G²'s may he the same as or different from each other and a plurality of D²'s may he the same as or different from each other.

Furthermore, G¹, G², and G³ each independently represent a divalent aromatic group which may have a substituent or a divalent alicyclic group which may have a substituent.

Examples of the divalent aromatic group include an aromatic hydrocarbon ring having 4 to 15 carbon atoms, and an aromatic heterocyclic ring.

Examples of the divalent alicyclic group include a cyclohexane ring, a cyclopeptane ring, a cyclooctane ring, a cyclododecane ring, and a cyclodocosane ring.

In addition, examples of the substituent which may be contained in G¹, G², and G³ include the same ones as the substituents which may be contained in Y¹ in Formula (Ar-1).

Moreover, Q represents a hydrogen atom, a monovalent aliphatic hydrocarbon group having 1 to 20 carbon atoms, a halogen atom, a cyano group, a nitro group, —OR⁶, —CO—OR⁶, —O—CO—R⁶, —NR⁷R⁸, —SR⁹, or a group represented by Formula (4), where R⁶ to R⁹ each independently represent a hydrogen atom or an alkyl group having 1 to 6 carbon atoms.

*-D³-G⁴-(D⁴-G⁵)ₘ-E²-SP²-L² (4)

Here, * represents a bonding position to G³ in Formula (3).

Furthermore, D³ and D⁴ are each the same as those described for D¹ and D² in Formula (1).

Moreover, E², SP², and L² are each the same as those described in the equation (1).

In addition, G⁴ and G⁵ are each the same as those described for G¹ to G³ in Formula (3).

Furthermore, in represents an integer of 0 to 2, and in a case where in is 2, a plurality of D⁴'s may be the same as or different from each other and a plurality of G⁵'s may be the same as or different from each other.

Such a polymerizable liquid crystal compound (3) is particularly preferably a polymerizable liquid crystal compound (3-1) exhibiting a smectic phase for a reason that each phase transition temperature of the polymerizable liquid crystal composition of the embodiment of the present invention can be controlled and a smectic phase can be stabilized, as a result, an optically anisotropic film exhibiting a homogeneous surface condition and homogeneous optical characteristics over the plane can be formed.

Specific examples of the polymerizable liquid crystal compound (3-1) include the polymerizable liquid crystal compounds shown below. Among those, a structure having a cyclohexyl group and a dicyclohexyl group in Formula (3) is more preferable for a reason that the control of the I/O value which will be described later becomes easy.

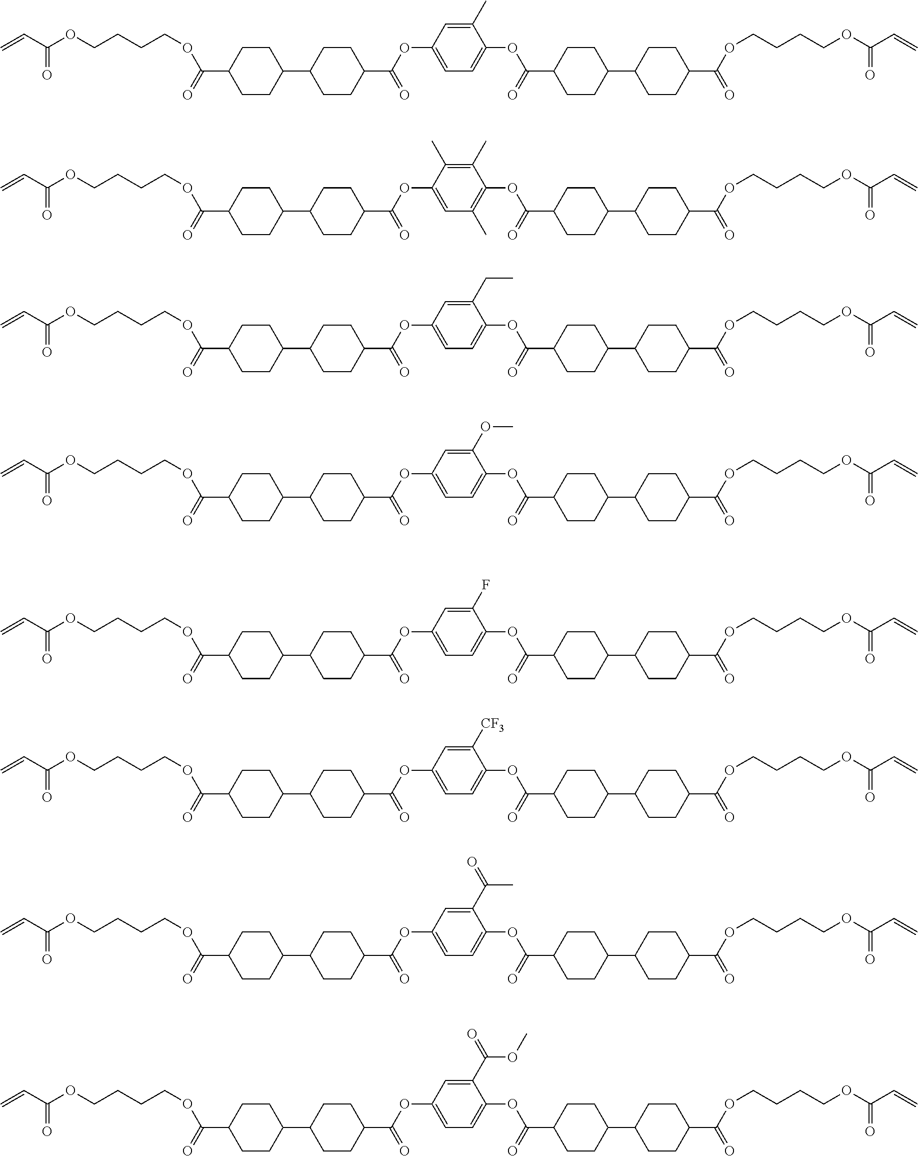

In the case where the polymerizable liquid crystal compound (3) is contained, a content thereof can be appropriately set from the viewpoint of controlling the wavelength dispersibility of the optically anisotropic film or the “I/O value” of the polymerizable liquid crystal composition which will he described later, in addition to the effect of improving the stability of a phase or the surface condition, but the content is preferably 1 to 80% by mass, and more preferably 3 to 70% by mass, with respect to a total mass of the polymerizable liquid crystal compounds (1) and (2) as described above.

In the present invention, for a reason that the moisture-heat resistance of the optically anisotropic film is improved, the I/O value of the liquid crystal compound included in the polymerizable liquid crystal composition of the embodiment of the present invention is preferably 0.51 or less, and more preferably 0.43 to 0.50 as a weighted average value. Incidentally, the liquid crystal compound for which the 110 value is determined is not limited to the polymerizable liquid crystal compounds represented by Formulae (1) to (3), and is any of the liquid crystal compounds included in the polymerizable liquid crystal composition of the embodiment of the present invention.

Here, the “I/O value” is used as one unit for predicting various physicochemical properties of an organic compound. The magnitude of organicity is obtained by comparison of the number of carbon atoms and the magnitude of inorganicity is obtained by comparison of the boiling points of the same number of hydrocarbons as the number of carbon atoms. For example, the organicity value of one (—CH₂—) (actually C) is determined as 20 and the inorganicity value is determined as 100 from an influence of a hydroxyl group (—OH) on the boiling point. Based on the inorganicity value of (OH) of 100, values of other substituents (inorganic groups) arc obtained, which is shown as an “inorganic group table”. According to the inorganic group table, the ratio I/O of inorganicity value and organicity (O) value obtained for each molecule is defined as “I/O value”. It is shown that the larger the I/O value, the higher the hydrophilicity thereof, and the smaller the I/O value, the stronger the hydrophobicity.

In the present invention, the “I/O value” is a value of “inorganicity (I)/organicity (O)” obtained by a method described in “YOSHIO KOUDA et al., “New edition: Organic Conceptual Diagram Foundation and Application”, November 2008, SANKYO PUBLISHING”.

<Polyfunctional Polymerizable Monomer>

For a reason that the optically anisotropic film is firmly aggregated and the moisture-heat resistance is further improved, it is preferable that the polymerizable liquid crystal composition of the embodiment of the present invention does not correspond to any of Formulae (1) to (3), and contains a polymerizable compound (polyfunctional polymerizable monomer) having two or more polymerizable groups.

The polyfunctional polymerizable monomer is preferably a polyfunctional radically polymerizable monomer. Specific examples of the polyfunctional radically polymerizable monomer include the polymerizable monomers described in paragraphs [0018] to [0020] of JP2002-296423A.

In addition, in a case where a polyfimctional polymerizable monomer is contained, a content thereof is preferably 1% to 50% by mass, and more preferably 2% to 30% by mass, with respect to a total mass of the liquid crystal compound.

<Additive with Alignment Improving Effect>

The polymerizable liquid crystal composition of the embodiment of the present invention may contain an additive having an alignment improving effect.

The additive may be polymerizable or non-polymerizable. Further, the additive may have liquid crystallinity, and in this case, it may be the same as the polymerizable liquid crystal compound (3).

Examples of the compound which improves the alignment state by the addition thereof include the alkylcyclohexane ring-containing compounds described in paragraphs [0022] to [0026] of WO2016/125839A, and the compounds described in the paragraphs [0024] to [0037] of JP2016-051178A.

In a case where the additive is contained, a content thereof can be appropriately set according to the effect of improving the stability of a liquid crystal phase and the alignment state, but is preferably 1% to 50% by mass, and more preferably 3% to 40% by mass, with respect to a total mass of the polymerizable liquid crystal compounds (1) and (2) as described above.

<Polymerization Initiator>

The polymerizable liquid crystal composition of the embodiment of the present invention preferably contains a polymerization initiator.

The polymerization initiator to be used is preferably a photopolymerization initiator capable of initiating a polymerization reaction upon irradiation with ultraviolet rays.

Examples of the photopolymerization initiator include α-carbonyl compounds (described in each of the specifications of U.S. Pat. No. 2,367,661A and U.S. Pat. No. 2,367,670A), acyloin ethers (described in the specification of U.S. Pat. No. 2,448,828A), α-hydrocarbon-substituted aromatic acyloin compounds (described in the specification of U.S. Pat. No. 2,722,512A), multinuclear quinone compounds (described in each of the specifications of U.S. Pat. No. 3,046,127A and U.S. Pat. No. 2,951,758A), combinations of a triarylimidazole dimer and a p-aminophenyl ketone (described in the specification of U.S. Pat. No. 3,549,367A), acridine and phenazine compounds (described in JP1985-105667A (JP-S60-105667A) and the specification of U.S. Pat. No. 4,239,850A), oxadiazole compounds (described in the specification of U.S. Pat. No. 4,212,970A), and acyl phosphine oxide compounds (described in JP1988-040799B (JP-S63-040799B), JP1993-029234B (JP-H05-029234B), JP1998-095788A (JP-H10-095788A), and JP1998-029997A (JP-H10-029997A)).

In the present invention, for a reason that the moisture-heat resistance is further improved, the polymerization initiator is preferably an oxime-type polymerization initiator, and specifically, more preferably a polymerization initiator represented by Formula (PI).

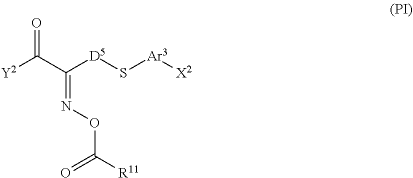

In Formula (PI), X² represents a hydrogen atom or a halogen atom.

Furthermore, in Formula (PI), Ar³ represents a divalent aromatic group and D⁵ represents a divalent organic group having 1 to 12 carbon atoms.

In addition, in Formula (PI), R¹¹ represents an alkyl group having 1 to 12 carbon atoms and Y² represents a monovalent organic group.

In Formula (PI), examples of the halogen atom represented by X² include a fluorine atom, a chlorine atom, a bromine atom, and an iodine atom, and among these, the chlorine atom is preferable.

Furthermore, in Formula (PI), examples of the divalent aromatic group represented by Ar³ include divalent groups having an aromatic hydrocarbon ring such as a benzene ring, a naphthalene ring, an anthracene ring, and a phenanthroline ring; and divalent groups having an aromatic heterocyclic ring such as a furan ring, a pyrrole ring, a thiophene ring, a pyridine ring, a thiazole ring, and a benzothiazole ring.

Incidentally, in Formula (PI), examples of the divalent organic group having 1 to 12 carbon atoms represented by D⁵ include a linear or branched alkylene group having 1 to 12 carbon atoms, and specific suitable examples thereof include a methylene group, an ethylene group, and a propylene group.

Moreover, in Formula (P1), specific suitable examples of the alkyl group having 1 to 12 carbon atoms represented by R¹¹ include a methyl group, an ethyl group, and a propyl group.

In addition, in Formula (PI), examples of the monovalent organic group represented by Y² include a functional group including a benzophenone skeleton ((C₆H₅)₂CO). Specifically, in a similar manner to the groups represented by Formula (PIa) and Formula (PIb), * functional group including a benzophenone skeleton in which a benzene ring at a terminal is unsubstituted or mono-substituted is preferable. Further, in Formula (PIa) and Formula (PIb), * represents a bonding position, and that is, a bonding position to the carbon atom of the carbonyl group in Formula (PI).

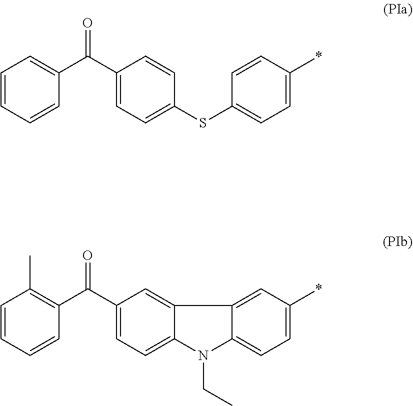 [SMILES: *c1ccc(Sc2ccc(C(=O)c3ccccc3)cc2)cc1 ; *c1ccc2c(c1)c1cc(C(=O)c3ccccc3C)ccc1n2CC]

Examples of the oxime-type polymerization initiator represented by Formula (PI) include a compound represented by Formula (PI-1) and a compound represented by Formula (PI-2).

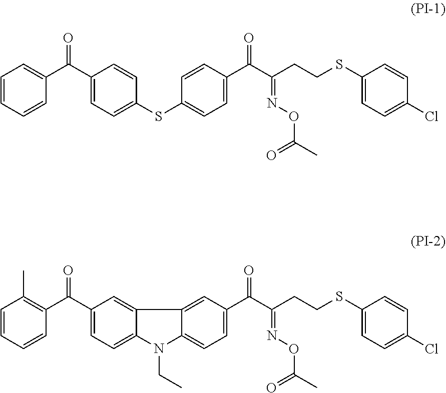 [SMILES: CC(=O)O/N=C(\CCSc1ccc(Cl)cc1)C(=O)c1ccc(Sc2ccc(C(=O)c3ccccc3)cc2)cc1 ; CCn1c2ccc(C(=O)/C(CCSc3ccc(Cl)cc3)=N/OC(C)=O)cc2c2cc(C(=O)c3ccccc3C)ccc21]

In the present invention, the content of the polymerization initiator is not particularly limited, but is preferably 0.01% to 20% by mass, and more preferably 0.5% to 5% by mass of the solid content of the polymerizable liquid crystal composition.

<Solvent>

It is preferable that the polymerizable liquid crystal composition of the embodiment of the present invention contains a solvent from the viewpoint of workability for forming an optically anisotropic film, and the like.

Specific examples of the solvent include ketones (for example, acetone, 2-butanone, methyl isobutyl ketone, cyclohexanone, and cyclopentanone), ethers (for example, dioxane and tetrahydrofuran), aliphatic hydrocarbons (for example, hexane), alicyclic hydrocarbons (for example, cyclohexane), aromatic hydrocarbons (for example, toluene, xylene, and trimethylbenzene), halogenated carbons (for example, dichloromethane, dichloroethane, dichlorobenzene, and chlorotoluene), esters (for example, methyl acetate, ethyl acetate, and butyl acetate), water, alcohols (for example, ethanol, isopropanol, butanol, and cyclohexanol), cellosolves (for example, methyl cellosolve and ethyl cellosolve), cellosolve acetates, sulfoxides (for example, dimethyl sulfoxide), and amides (for example, dimethylformamide and dimethylacetamide), and these may be used singly or in combination of two or more kinds thereof.

<Leveling Agent>

It is preferable that the polymerizable liquid crystal composition of the embodiment of the present invention contains a leveling agent from the viewpoint that the surface of an optically anisotropic film is maintained smooth and the alignment is easily controlled.

Such a leveling agent is preferably a fluorine-based leveling agent or a silicon-based leveling agent for a reason that it has a high leveling effect on the addition amount, and the leveling agent is more preferably a fluorine-based leveling agent from the viewpoint that it is less likely to cause bleeding (bloom or bleed).

Specific example of the leveling agent include the compounds described in paragraphs [0079] to [0102] of JP2007-069471A, the compound. represented by General Formula (I) described in JP2013-047204A (in particular, the compounds described in paragraphs [0020] to [0032]), the compound represented by General Formula (I) described in JP2012-211306A (in particular, the compounds described in paragraphs [0022] to [0029]), the liquid crystal alignment accelerator represented by General Formula (I) described in JP2002-129162A (in particular, the compounds described in paragraphs [0076] to [0078] and [0082] to [0084]), and the compounds represented by General Formulae (I), (II), and (III) described in JP2005-099248A (in particular, the compounds described in paragraphs [0092] to [0096]). In addition, the leveling agent may also function as an alignment control agent which will be described later.

<Alignment Control Agent>

The polymerizable liquid crystal composition of the embodiment of the present invention can contain an alignment control agent, as desired.

With the alignment control agent, various alignment states such as homeotropic alignment (vertical alignment), tilt alignment, hybrid alignment, and cholesteric alignment can be formed, in addition to the homogeneous alignment, and specific alignment states can be controlled and achieved more uniformly and more accurately.

As an alignment control agent which accelerates the homogeneous alignment, for example, a low-molecular-weight alignment control agent or a high-molecular-weight alignment control agent can be used.

With regard to the low-molecular-weight alignment control agent, reference can be made to the description in, for example, paragraphs [0009] to [0083] of JP2002-020363A, paragraphs [0111] to [0120] of JP2006-106662A, and paragraphs [0021] to [0029] of JP2012-211306A, the contents of which are hereby incorporated by reference.

In addition, with regard to the high-molecular-weight alignment control agent, reference can be made to the description in, for example, paragraphs [0021] to [0057] of JP2004-198511A and paragraphs [0121] to [0167] of JP2006-106662A, the contents of which are hereby incorporated by reference.

Furthermore, examples of the alignment control agent that forms or accelerates the homeotropic alignment include a boronic acid compound and an onium salt compound, and specifically; reference can he made to the compounds described in paragraphs [0023] to [0032] of JP2008-225281A, paragraphs [0052] to [0058] of JP2012-208397A, paragraphs [0024] to of JP2008-026730A, paragraphs [0043] to [0055] of JP2016-193869A, and the like, the contents of which are hereby incorporated by reference.

On the other hand, the cholesteric alignment can be achieved by adding a chiral agent to the polymerizable liquid crystal composition of the embodiment of the present invention, and it is possible to control the direction of revolution of the cholesteric alignment by its chiral direction. Incidentally, it is possible to control the pitch of the cholesteric alignment in accordance with the alignment regulating force of the chiral agent.

In a case where an alignment control agent is contained, a content thereof is preferably 0.01% to 10% by mass, and more preferably 0.05% to 5% by mass, with respect to the mass of the total solid content of the polymerizable liquid crystal composition. In a case where the content is within the range, it is possible to obtain an optically anisotropic film which has no precipitation or phase separation, alignment defects, or the like, and is uniform and highly transparent while achieving a desired alignment state.

These alignment control agents can further impart a polymerizable functional group, in particular, a polymerizable functional group which is polymerizable with a polymerizable liquid crystal compound constituting the polymerizable liquid crystal composition of the embodiment of the present invention.

<Other Components>

The polymerizable liquid crystal composition of the embodiment of the present invention may contain components other than the above-mentioned components, and examples of such other components include a liquid crystal compound other than the above-mentioned polymerizable liquid crystal compound, a surfactant, a tilt angle control agent, an alignment aid, a plasticizer, and a crosslinking agent.

<Formation Method>

Examples of a method for forming the optically anisotropic film include a method in which the above-mentioned polymerizable liquid crystal composition of the embodiment of the present invention is used to cause a desired alignment: state, which is then fixed by polymerization.

Here, the polymerization conditions are not particularly limited, but in the polymerization by irradiation with light, ultraviolet rays are preferably used. The irradiation dose is preferably 10 mJ/cm² to 50 J/cm², more preferably 20 mJ/cm² to 5 J/cm², still more preferably 30 mJ/cm² to 3 J/cm², and particularly preferably 50 mJ/cm² to 1,000 mJ/cm². In addition, the polymerization may be carried out under a heating condition in order to accelerate the polymerization reaction.

Incidentally, in the present invention, the optically anisotropic film can be formed on a photo-alignment film in the optical film of the embodiment of the present invention which will be described later.

The thickness of such an optically anisotropic film is preferably 0.1 to 10 μm, more preferably 0.1 to 5 μm, and still more preferably 0.1 μm or more and less than 3 μm, from the viewpoint of reducing the thickness.

As described above, the optically anisotropic film of the optical film of the embodiment of the present invention satisfies the following Formula (I) or (II), and preferably satisfies Formula (III) in a case where it satisfies Formula (I).

Re(450)/Re(550)<1 (I)

Rth(450)/Rth(550)<1 (II)

0.50<Re(450)/Re(550)<1.00 (III)

In Formulae (I) and (III), Re(450) represents an in-plane retardation of the optically anisotropic film at a wavelength of 450 nm, and Re(550) represents an in-plane retardation of the optically anisotropic film at a wavelength of 550 nm.

In addition, in Formula (II), Rth(450) represents a thickness-direction retardation of the optically anisotropic film at a wavelength of 450 nm, and Rth(550) represents a thickness-direction retardation of the optically anisotropic film at a wavelength of 550 nm.

In the present invention, the values of the in-plane retardation and the thickness-direction retardation refer to values measured with light at the measurement wavelength using AxoScan OPMF-1 (manufactured by Opto Science, Inc.).

Specifically, by inputting the average refractive index ((Nx+Ny+Nz)/3) and the film thickness (d (μm)) to AxoScan OPMF-1, it is possible to calculate:

Slow axis direction (°)

Re(λ)=R0(λ)

Rth(λ)=((nx+ny)/2−nz)×d.

In addition, R0(λ) is expressed in a numerical value calculated with AxoScan OPMF-1, but means Re(λ).

Furthermore, the optically anisotropic film included in the optical film of the embodiment of the present invention exhibits a diffraction peak derived from a periodic structure in X-ray diffraction measurement.

Here, suitable examples of an aspect exhibiting the above-mentioned diffraction peak include an aspect in which molecules adjacent in the direction vertical to the alignment axis forms a layer and this layer is laminated in the direction parallel to the alignment axis, that is, an aspect exhibiting a smectic phase. Further, from the viewpoint that such a smectic phase is easily expressed, it is preferable that the above-mentioned polymerizable liquid crystal compound (1) is a compound exhibiting a smectic phase in any of a case where the temperature is elevated and a case where the temperature is lowered.

In addition, whether or not the above-mentioned diffraction peak is exhibited can also be confirmed by observing a texture characteristic of a liquid crystal phase having a periodic structure with a polarizing microscope.

The optically anisotropic film included in the optical film of the present invention is preferably a positive A-plate or a positive C-plate, and more preferably the positive A-plate.

Incidentally, in a case where the optically anisotropic film is the positive A-plate, it satisfies Formula (I), and in a case where the optically anisotropic film is the positive C-plate, it satisfies Formula (II).

Here, the positive A-plate (A-plate which is positive) and the positive C-plate (C-plate which is positive) are defined as follows.

In a case where a refractive index in a film in-plane slow axis direction (in a direction in which an in-plane refractive index is maximum) is defined as nx, a refractive index in an in-plane direction orthogonal to the in-plane slow axis is defined as ny, and a refractive index in a thickness direction is defined as nz, the positive A-plate satisfies the relationship of Formula (A1) and the positive C-plate satisfies the relationship of Formula (C1). In addition, the positive A-plate has an Rth showing a positive value and the positive C-plate has an Rth showing a negative value.

nx>ny≈nz Formula (A1)

nz>nx≈ny Formula (C1)

Furthermore, the symbol, “≈”, encompasses not only a case where the both are completely the same as each other but also a case where the both are substantially the same as each other.

The expression, “substantially the same”, means that with regard to the positive A-plate, for example, a case where (ny−nz)×d (in which d is the thickness of a film) is −10 to 10 nm, and preferably −5 to 5 nm is also included in “ny≈nz”, and a case where (nx−nz)×d is −10 to 10 nm, and preferably −5 to 5 nm is also included in “nx≈nz”. In addition, with regard to the positive C-plate, for example, a case where (nx−ny)×d (in which d is the thickness of a film) is 0 to 10 nm, and preferably 0 to 5 nm is also included in “nx≈ny”.

[Photo-Alignment Film]

The optical film of the embodiment of the present invention involves no occurrence of fine dust (hereinafter also referred to as “rubbing dust”) due to a rubbing treatment, and has a photo-alignment film from the viewpoint of significantly suppressing the occurrence of alignment defects caused by the rubbing dust.

The photo-alignment film is not particularly limited, but the polymer materials such as a polyamide compound and a polyimide compound, described in paragraphs 0024 to 0043 of WO2005/096041A; the liquid crystal alignment film formed by a liquid crystal aligning agent having a photo-alignment group, described in JP2012-155308A; LPP-JP265CP, trade name, manufactured by Rolic Technologies Ltd.; or the like can be used.

In the present invention, the thickness of the photo-alignment film is not particularly limited, but from the viewpoint of forming an optically anisotropic film having a homogeneous film thickness by alleviating the surface roughness which can be present on any support which will be described later, the thickness is preferably 0.01 to 10 μm, more preferably 0.01 to 1 μm, and still more preferably 0.01 to 0.5 μm;

[Support]

The optical film of the embodiment of the present invention may have a support as a base material for forming an optically anisotropic film described above.

Such a support is preferably transparent, and specifically, it preferably has a light transmittance of 80% or more.

Examples of such a support include a glass substrate and a polymer film, and examples of the material for the polymer film include cellulose-based polymers; acrylic polymers having an acrylic ester polymer such as polymethyl methacrylate and a lactone ring-containing polymer; thermoplastic norbornene-based polymers; polycarbonate-based polymers; polyester-based polymers such as polyethylene terephthalate and polyethylene naphthalate; styrene-based polymers such as polystyrene and an acrylonitrile-styrene copolymer (AS resin); polyolefin-based polymers such as polyethylene, polypropylene, and an ethylene-propylene copolymer; vinyl chloride-based polymers; amide-based polymers such as nylon and aromatic polyamide; imide-based polymers; sulfone-based polymers; polyether sulfone-based polymers; polyether ether ketone-based polymers; polyphenylene sulfide-based polymers; vinylidene chloride-based polymers; vinyl alcohol-based polymers; vinyl butyral-based polymers; arylate-based polymers; polyoxymethylene-based polymers; epoxy-based polymers; and polymers obtained by mixing these polymers.

In addition, an aspect in which a polarizer which will be described later may also function as such a support is also available.

In the present invention, the thickness of the support is not particularly limited, but is preferably 5 to 60 μm, and more preferably 5 to 30 μm.

[Hard Coat Layer]

It is preferable that the optical film of the embodiment of the present invention has a hard coat layer in order to impart physical strength to the film. Specifically, the optical film may have the hard coat layer on the side of the support opposite to the side on which the photo-alignment film is provided or the optical film may have the hard coat layer on the side of the optically anisotropic film opposite to the side on which the photo-alignment film is provided.

As the hard coat layer, those described in paragraphs [0190] to [0196] of JP2009-098658A can be used.

[Other Optically Anisotropic Films]

The optical film of the embodiment of the present invention may have other optically anisotropic films, in addition to the optically isotropic film obtained by polymerizing the polymerizable liquid crystal composition of the embodiment of the present invention.

That is, the optical film of the embodiment of the present invention may have a laminated structure having the optically anisotropic film of the embodiment of the present invention and other optically anisotropic films.

Such other optically anisotropic films are not particularly limited as long as the optically anisotropic films are optically anisotropic films obtained by blending only the above-mentioned polymerizable liquid crystal compound (2) while not blending the above-mentioned polymerizable liquid crystal compound (1), or by using other polymerizable compounds (in particular, liquid crystal compounds).

Here, the liquid crystal compounds can be generally classified into a rod-shaped type and a disk-shaped type according to the shape thereof. Each of the types can further be classified into a low-molecular-weight type and a high-molecular-weight type. The term, high-molecular-weight, generally refers to having a degree of polymerization of 100 or more (Polymer Physics-Phase Transition Dynamics, by Masao Doi, page 2, published by Iwanami Shoten, Publishers, 1992). In the present invention, any of the liquid crystal compounds can be used, but the rod-shaped liquid crystal compound or the discotic liquid crystal compound (disk-shaped liquid crystal compound) is preferably used. Two or more kinds of the rod-shaped liquid crystal compounds, two or more kinds of the disk-shaped liquid crystal compounds, or a mixture of the rod-shaped liquid crystal compound and the disk-shaped liquid crystal compound may be used. In order to fix the above-mentioned liquid crystal compound, it is more preferable that the liquid crystal compound is formed of a rod-shaped liquid crystal compound or disk-shaped liquid crystal compound having a polymerizable group, and it is still more preferable that the liquid crystal compound has two or more polymerizable groups in one molecule. In the case of a mixture of two or more. kinds of the liquid crystal compounds, at least one kind of the liquid crystal compound preferably has two or more polymerizable groups in one molecule.

As the rod-shaped liquid crystal compound, for example, the rod-shaped liquid crystal compounds described in claim 1 of JP1999-513019A (JP-H11-513019A) or paragraphs [0026] to [0098] of JP2005-289980A can be preferably used, and as the discotic liquid crystal compound, for example, the discotic liquid crystal compounds described in paragraphs [0020] to [0067] of JP2007-108732A and paragraphs [0013] to [0108] of JP2010-244038A can be preferably used, but the liquid crystal compounds are not limited thereto.

[Ultraviolet Absorber]

The optical film of the embodiment of the present invention preferably includes an ultraviolet (UV) absorber, taking an effect of external light (particularly ultraviolet rays) into consideration.

The ultraviolet absorber may be contained in the optically anisotropic film of the embodiment of the present invention or may also be contained in a member other than an optically anisotropic film constituting the optical film of the embodiment of the present invention. Suitable examples of the member other than the optically anisotropic film include a support.

As the ultraviolet absorber, any one of ultraviolet absorbers known in the related art, which can express ultraviolet absorptivity, can be used. Among such the ultraviolet absorbers, a benzotriazole-based or hydroxyphenyltriazine-based ultraviolet absorber is preferably used from the viewpoint that it has high ultraviolet absorptivity and ultraviolet absorbing ability (ultraviolet-shielding ability) used for an image display device is obtained.

In addition, in order to broaden ultraviolet absorbing ranges, two or more of ultraviolet absorbers having different maximum absorption wavelengths can be used in combination.

Specific examples of the ultraviolet absorber include the compounds described in paragraphs [0258] and [0259] of JP2012-018395A and the compounds described in paragraphs [0055] to [0105] of JP2007-072163A.

In addition, as a commercially available product thereof, for example, Tinuvin 400, Tinuvin 405, Tinuvin 460, Tinuvin 477, Tinuvin 479, and Tinuvin. 1577 (all manufactured by BASF), or the like can be used.

[Polarizing Plate]

A polarizing plate of an embodiment of the present invention has the above-mentioned optical film of the embodiment of the present invention and a polarizer.

[Polarizer]

A polarizer contained in a polarizing plate of an embodiment of the present invention is not particularly limited as long as it is a member having a function of converting light into specific linearly polarized light, and an absorptive type polarizer and a reflective type polarizer, which are known in the related art, can be used.

An iodine-based polarizer, a dye-based polarizer using a dichroic dye, a polyene-based polarizer, or the like is used as the absorptive type polarizer. The iodine-based polarizer and the dye-based polarizer are classified into a coating type polarizer and a stretching type polarizer, any of which can he applied, but a polarizer which is manufactured by allowing polyvinyl alcohol to adsorb iodine or a dichroic dye and performing stretching is preferable.

In addition, examples of a method of obtaining a polarizer by carrying out stretching and dyeing in a state of a laminated film in which a polyvinyl alcohol layer is formed on a base material include the methods disclosed in JP5048120B, JP5143918B, JP4691205B, JP4751481B, and JP4751486B, and known technologies relating to these polarizers can also be preferably used.

A polarizer in which thin films having different birefringence are laminated, a wire grid-type polarizer, a polarizer having a combination of a cholesteric liquid crystal having a selective reflection range and a ¼ wavelength plate, or the like is used as the reflective type polarizer.

Among those, a polarizer including a polyvinyl alcohol-based resin (a polymer including —CH₂—CHOH— as a repeating unit, in particular, at least one selected from the group consisting of a polyvinyl alcohol and an ethylene-vinyl alcohol copolymer) is preferable from the viewpoint that it has more excellent adhesiveness.

In the present invention, the thickness of the polarizer is not particularly limited, but is preferably 3 μm to 60 μm, more preferably 5 μm to 30 μm, and still more preferably 5 μm to 15 μm.

[Pressure-Sensitive Adhesive Layer]

The polarizing plate of the embodiment of the present invention may have a pressure-sensitive adhesive layer arranged between the optically anisotropic film in the optical film of the embodiment of the present invention and the polarizer.

The pressure-sensitive adhesive layer used for lamination of the optically anisotropic film and the polarizer represents, for example, a substance in which a ratio (tan δ=G″/G′) between a storage elastic modulus G′ and a loss elastic modulus G″, each measured with a dynamic viscoelastometer, is 0.001 to 1.5, and examples thereof include a so-called pressure-sensitive adhesive or a readily creepable substance. Examples of the pressure-sensitive adhesive that can be used in the present invention include a polyvinyl alcohol-based pressure-sensitive adhesive, but the pressure-sensitive adhesive is not limited thereto.

[Image Display Device]

An image display device of an embodiment of the present invention is an image display device having the optical film of the embodiment of the present invention or the polarizing plate of the embodiment of the present invention.

A display element used in the image display device of the embodiment of the present invention is not particularly limited, and examples thereof include a liquid crystal cell, an organic electroluminescent (hereinafter simply referred to as “EL”) display panel, and a plasma display panel.

Among those, the liquid crystal cell and the organic EL display panel are preferable, and the liquid crystal cell is more preferable. That is, as the image display device of the embodiment of the present invention, a liquid crystal display device using a liquid crystal cell as a display element or an organic EL display device using an organic EL display panel as a display element is preferable, and the liquid crystal display device is more preferable.

[Liquid Crystal Display Device]

A liquid crystal display device which is an example of the image display device of the embodiment of the present invention is a liquid crystal display device having the above-mentioned polarizing plate of the embodiment of the present invention and a liquid crystal cell.

In addition, in the present invention, it is preferable that the polarizing plate of the embodiment of the present invention is used as the polarizing plate of the front side, and it is more preferable that the polarizing plate of the embodiment of the present invention is used as the polarizing plates on the front and rear sides, among the polarizing plates provided on the both sides of the liquid crystal cell.

Hereinafter, the liquid crystal cell constituting the liquid crystal display device will be described in detail.

<Liquid Crystal Cell>

A liquid crystal cell for use in the liquid crystal display device is preferably in a vertical alignment (VA) mode, an optically compensated bend (OCB) mode, an in-plane-switching (IPS) mode, or a twisted nematic (TN) mode, but the liquid crystal cell is not limited thereto.

In a TN-mode liquid crystal cell, rod-shaped liquid crystal molecules are substantially horizontally aligned and are twist-aligned at 60° to 120° during no voltage application thereto. A TN-mode liquid crystal cell is most often used in a color TFT liquid crystal display device and described in numerous documents.

In a VA-mode liquid crystal cell, rod-shaped liquid crystal molecules are substantially vertically aligned during no voltage application thereto. Examples of the VA-mode liquid crystal cell include (1) a VA-mode liquid crystal cell in the narrow sense of the word, in which rod-shaped liquid crystal molecules are substantially vertically aligned during no voltage application thereto, but are substantially horizontally aligned during voltage application thereto (described in JP 1990-176625A (JP-H02-176625A)), (2) an MVA-mode liquid crystal cell in which the VA mode is multi-domained for viewing angle enlargement (described in SID97, Digest of Tech. Papers (preprint), 28 (1997) 845), (3) a liquid crystal cell in a mode (n-ASM mode) in which rod-shaped liquid crystal molecules are substantially vertically aligned during no voltage application thereto and are multi-domain-aligned during voltage application thereto (described in Seminar of Liquid Crystals of Japan, Papers (preprint), 58-59 (1998)), and (4) a survival-mode liquid crystal cell (announced in LCD International 98). In addition, the liquid crystal cell may be of any of a patterned vertical alignment (PVA) type, an optical alignment type, and polymer-sustained alignment (PSA) type. Details of these modes are specifically described in JP2006-215326A and JP2008-538819A.

In an IPS-mode liquid crystal cell, rod-shaped liquid crystal molecules are aligned substantially parallel with respect to a substrate, and application of an electric field parallel to the substrate surface causes the liquid crystal molecules to respond planarly. The IPS mode displays black in a state where no electric field is applied and a pair of upper and lower polarizing plates have absorption axes which are orthogonal to each other. A method of improving the viewing angle by reducing tight leakage during black display in an oblique direction using an optical compensation sheet is disclosed in JP1998-054982A (JP-H10-054982A), JP1999-202323A (JP-H11-202323A), JP1997-292522A (JP-H09-292522A), JP1999-133408A (JP-H11-133408A), JP1999-305217A (JP-H11-305217A), JP1998-307291 A (JP-H10-307291A), and the like.

[Organic EL Display Device]

Suitable examples of the organic EL display device which is an example of the image display device of the embodiment of the present invention include an aspect which includes, from the visible side, the polarizing plate of the embodiment of the present invention, a plate having a λ/4 function (hereinafter also referred to as a “λ/4 plate”), and an organic EL display panel in this order.

Here, the “plate having a λ/4 function” refers to a plate having a function of converting linearly polarized light at a specific wavelength into circularly polarized light (or converting circularly polarized light into linearly polarized light), specific examples of the plate in which the λ/4 plate is a single-layer structure include a stretched polymer film, and a phase difference film provided with an optically anisotropic film having a λ/4 function on a support, and specific examples of an aspect in which the λ/4 plate is a multilayer structure include a broadband λ/4 plate obtained by laminating a λ/4 plate and a λ/2 plate.

Furthermore, the organic EL display panel is a display panel composed of an organic EL element in which an organic light emitting layer (organic electroluminescent layer) is sandwiched between electrodes (between a cathode and an anode). The configuration of the organic EL display panel is not particularly limited but a known configuration is adopted.

### EXAMPLES

Hereinafter, the features of the present invention will be described in more details with reference to Examples and Comparative Examples. The materials, the amounts of materials used, the proportions, the treatment details, the treatment procedure, and the like shown in Examples below can be appropriately modified as long as the modifications do not depart from the spirit of the present invention. Therefore, the scope of the present invention should not be construed as being limited to specific examples shown below.

### Example 1

<Synthesis of Polymer PA-1 Having Photo-Alignment Group>

According to the method described for Langmuir, 32(36), 9245-9253 (2016), a monomer m-1 shown below was synthesized using 2-hydroxyethyl methacrylate (HEMA) (a reagent from Tokyo Chemical industry Co., Ltd.) and the following cinnamic acid chloride derivative.

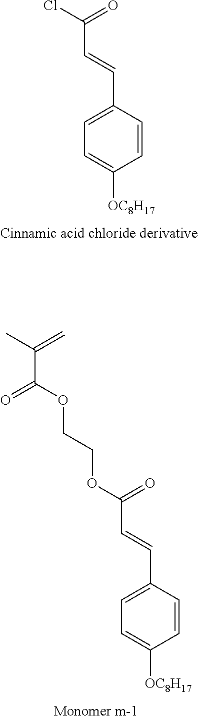

5 parts by mass of 2-butanone was introduced as a solvent into a flask equipped with a cooling pipe, a thermometer, and a stirrer, nitrogen was flowed into the flask. at 5 mL/min, and the flask was refluxed under heating in a water bath. A solution obtained by mixing 5 parts by mass of the monomer m-1, 5 parts by mass of CYCLOMER M100 (manufactured by Daicel Chemical Industries, Ltd.), 1 part by mass of 2,2′-azobis(isobutyronitrile) as a polymerization initiator, and 5 parts by mass of 2-butanone as a solvent was added dropwise thereto for 3 hours, and the mixture was further stirred for 3 hours while keeping the refluxing state. After completion of the reaction, the mixture was left to be cooled to room temperature and diluted by addition of 30 parts by mass of 2-butanone to obtain an about 20%-by-mass polymer solution, The obtained polymer solution was put into methanol in a large excess to precipitate a polymer, and the recovered precipitate was separated by filtration and washed with a large amount of methanol, and then dried with air blast at 50° C. for 12 hours to obtain a polymer PA-1 having a photo-alignment group.

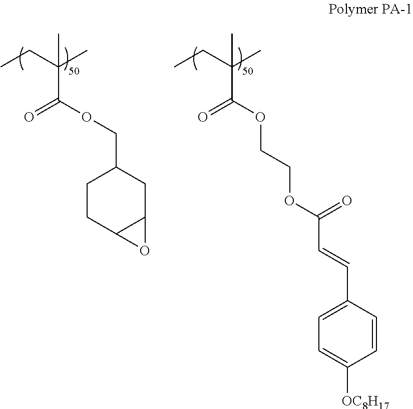

<Manufacture of Photo-Alignment Film P-1>

A coating liquid for forming a photo-alignment film P-1 having the following formulation was continuously applied onto a support, using a commercially available triacetyl cellulose film “TD80UL” (manufactured by FUJIFILM Corporation) as a temporary support for formation with a #2.4 wire bar.

The support on which the coating film had been formed was dried with hot air at 140° C. for 120 seconds, and then irradiated with polarized ultraviolet rays at 10 mJ/cm² (measurement wavelength: 315 nm, using an ultra-high pressure mercury lamp) through a wire grid polarizer (ProFlux PPL02 manufactured by Moxtek, Inc.) to form a photo-alignment film P-1.

(Coating Liquid for Forming Photo-Alignment Film P-1)

| | |
|---|---|
| The polymer PA-1 | 100.00 parts by mass |
| Isopropyl alcohol | 16.50 parts by mass |
| Butyl acetate | 1,072.00 parts by mass |
| Methyl ethyl ketone | 268.00 parts by mass |

<Formation of Positive A-Plate A-1>

The following composition A-1 was applied onto the photo-alignment film P-1 using a bar coater. The coating film formed on the photo-alignment film P-1 was heated to 145° C. with hot air and then cooled to 70° C., and the coating film was irradiated with ultraviolet rays at 100 mJ/cm² at a wavelength of 365 nm in a nitrogen atmosphere using a high-pressure mercury lamp and subsequently irradiated with ultraviolet rays at 500 mJ/cm² under heating to 120° C. to fix the alignment of the liquid crystal compound, thereby manufacturing a film A-1 including a positive A-plate A-1. The thickness of the positive A-plate A-1 is shown in Table 3 below. In addition, the weighted average value of I/O values of the liquid crystal compounds in the following composition A-1 is shown in Table 3 below.

(Composition A-1)

| | |
|---|---|
| The following polymerizable liquid crystal compound L-1 | 32.00 parts by mass |
| The following polymerizable liquid crystal compound L-2 | 48.00 parts by mass |
| The following polymerizable liquid crystal compound L-3 | 20.00 parts by mass |
| The following polymerization initiator PI-1 | 0.50 parts by mass |
| The leveling agent T-1 | 0.20 parts by mass |
| Cyclopentanone | 235.00 parts by mass |

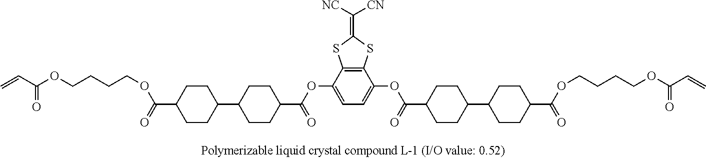 [SMILES: C=CC(=O)OCCCCOC(=O)C1CCC(C2CCC(C(=O)Oc3ccc(OC(=O)C4CCC(C5CCC(C(=O)OCCCCOC(=O)C=C)CC5)CC4)c4c3SC(=C(C#N)C#N)S4)CC2)CC1]

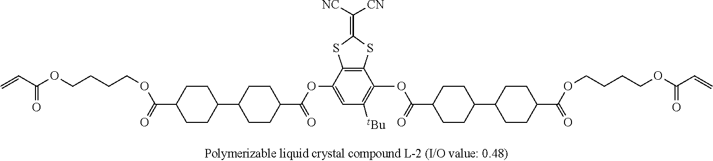 [SMILES: C=CC(=O)OCCCCOC(=O)C1CCC(C2CCC(C(=O)Oc3cc(C(C)(C)C)c(OC(=O)C4CCC(C5CCC(C(=O)OCCCCOC(=O)C=C)CC5)CC4)c4c3SC(=C(C#N)C#N)S4)CC2)CC1]

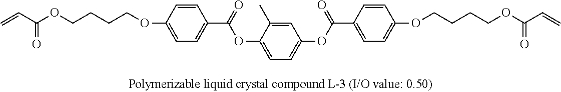 [SMILES: C=CC(=O)OCCCCOc1ccc(C(=O)Oc2ccc(OC(=O)c3ccc(OCCCCOC(=O)C=C)cc3)c(C)c2)cc1]

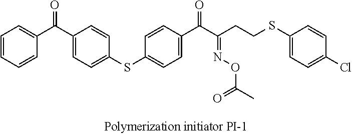 [SMILES: CC(=O)O/N=C(\CCSc1ccc(Cl)cc1)C(=O)c1ccc(Sc2ccc(C(=O)c3ccccc3)cc2)cc1]

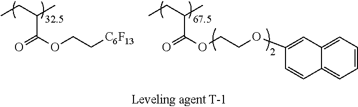

<Phase Transition Temperature>

Here, the phase transition temperatures of the polymerizable liquid crystal compounds L-1 and L-2 were confirmed by texture observation with a polarizing microscope.

The polymerizable liquid crystal compound L-1 changed from a crystalline solid to a liquid crystal phase having a texture specific to a smectic phase at around 136° C. as the temperature was elevated. In a case where the temperature was further elevated, the phase changed to a nematic phase at 197° C., and the nematic phase was maintained at up to about 250° C., but since polymerization proceeded at the same time, no transition to an isotropic phase was observed. The phase became a nematic phase at around 238° C., became a smectic phase at around 197° C., and became a crystal at around 136° C. That is, it was found that the polymerizable liquid crystal compound L-1 exhibited a smectic phase at 136° C. to 197° C. and a nematic phase at 197° C. to 238° C. in a case where the temperature was elevated and lowered.

The same observation was performed for the polymerizable liquid crystal compound L-2, and it was found that the compound exhibited a nematic phase at 143° C. to 208° C. and had no temperature range exhibiting the smectic phase in a case where the temperature was elevated and lowered.

<X-Ray Diffraction Measurement>

Moreover, X-ray diffraction measurement was performed on the positive A-plate A-1 formed on the photo-alignment film using the following apparatus under the following conditions, and thus, a peak exhibiting a layer structure was observed at 2θ-2.36° and diffracted light caused by the order of the smectic phase could be confirmed.

(Apparatus and Conditions)

X-ray diffractometer ATXG, Cu source (50 kV•300 mA), 0.45 solar slit

### Example 2

<Manufacture of Photo-Alignment Film P-2>

Using a glass plate as a temporary support for formation, a coating liquid for forming a photo-alignment film P-1 was applied onto the glass plate with a #2 wire bar. The support on which the coating film had been formed was dried with hot air at 140° C. for 120 seconds, and subsequently irradiated with polarized ultraviolet rays at 1,000 mJ/cm² (measurement wavelength of 360 nm using a high-pressure mercury lamp) through a wire grid polarizer (ProFlux PPL02 manufactured by Moxtek, Inc.) to form a photo-alignment film P-2.

(Coating Liquid for Forming Photo-Alignment Film P-2)

| | |
|---|---|
| The following materials for photo-alignment | 2 parts by mass |
| Butyl acetate | 33 parts by mass |
| Dipropylene glycol monomethyl ether | 33 parts by mass |
| Pure water | 33 parts by mass |

Material for Photo-Alignment

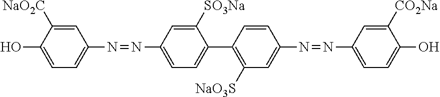

<Formation of Positive A-Plate A-2>

The composition A-1 was applied onto the photo-alignment film P-2 by a spin coating method. The coating film formed on the photo-alignment film P-2 was heated to 145° C. with hot air and then cooled to 70° C., and the coating film was irradiated with ultraviolet rays at 100 mJ/cm² at a wavelength of 365 nm in a nitrogen atmosphere using a high-pressure mercury lamp and subsequently irradiated with ultraviolet rays at 500 mJ/cm² under heating to 120° C. to fix the alignment of the liquid crystal compound, thereby manufacturing a film A-2 including a positive A-plate A-2. The thickness of the positive A-plate A-2 is shown in Table 3 below.

In addition, in a case where the X-ray diffraction measurement of the positive A-plate A-2 was performed by the same method as in Example 1, a peak exhibiting the same layer structure as the positive A-plate A-1 was observed.

### Comparative Example 1

<Manufacture of Alignment Film P-3>

Using a glass plate as a temporary support for formation, the following coating liquid for forming an alignment film P-3 was applied onto a glass substrate using a #18 bar coater, and the glass substrate was dried with hot air at 100° C. for 120 seconds and then subjected to a rubbing treatment to form an alignment film P-3.

(Coating Liquid for Forming Alignment Film P-3)

| | |
|---|---|
| Polyvinyl alcohol (PVA 203 | 2.0 parts by mass |
| manufactured by Kuraray C., Ltd.) | |
| Water | 98.0 parts by mass |

<Formation of Positive A-Plate A-3>

A positive A-plate A-3 was manufactured by the same method as in Example 2, except that the alignment film P-3 was used instead of the photo-alignment film P-2.

The X-ray diffraction. measurement of the positive A-plate A-3 was performed by the same method as in Example 1, and thus, a peak having the same layer structure as that of the positive A-plate A-1 was observed.

### Comparative Example 2

<Formation of Positive A-Plate A-4>

The composition. A-1 was applied onto the photo-alignment film P-2 provided on a temporary support for formation (glass plate) using a spin coater. The coating film formed on the photo-alignment film P-2 was heated to 180° C. with hot air, and the coating film was irradiated with ultraviolet rays at 500 mJ/cm² in a nitrogen atmosphere while maintaining the temperature to fix the alignment of the liquid crystal compound, thereby manufacturing a glass plate A-4 including a positive A-plate A-4. The thickness of the positive A-plate A-4 is shown in Table 3 below.

The X-ray diffraction measurement of the positive A-plate A-4 was performed by the same method as in Example 1, and thus, no peak exhibiting the same layer structure as the positive A-plate A-1 was observed.

### Example 3

<Formation of Positive A-Plate A-5>

The following composition A-5 was applied onto the photo-alignment film P-2 provided on a temporary support for formation (glass plate) using a spin coater. The coating film formed on the photo-alignment film P-2 was heated to 200° C. with hot air, and then the coating film was irradiated with ultraviolet rays at 500 mJ/cm² in a nitrogen atmosphere while maintaining the temperature at 180° C. to fix the alignment of the liquid crystal compound, thereby manufacturing a glass plate A-5 including a positive A-plate A-5. The thickness of the positive A-plate A-5 is shown in Table 3 below. In addition, the weighted average value of values of the liquid crystal compounds in the following composition A-5 is shown in Table 3 below.

The X-ray diffraction measurement of the positive A-plate A-5 was performed by the same method as in Example 1, and thus, no peak exhibiting the same layer structure as the positive A-plate A-1 was observed.

(Composition A-5)

| | |
|---|---|
| The polymerizable liquid crystal compound L-1 | 80.00 parts by mass |
| The polymerizable liquid crystal compound L-3 | 20.00 parts by mass |
| The polymerization initiator PI-1 | 0.50 parts by mass |
| The leveling agent T-1 | 0.20 parts by mass |
| Chloroform | 570.00 parts by mass |

### Comparative Example 3

<Synthesis of Liquid Crystal Compound>

The following polymerizable liquid crystal compounds L-4 and L-5 were synthesized according to the method described in paragraphs [0122], [0190], and [0191] of R2016-081035A.

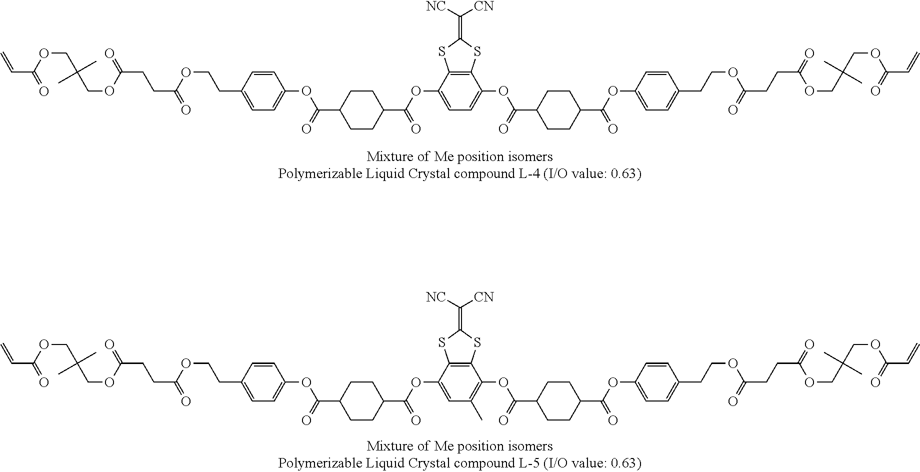

<Phase Transition Temperature>

Here, the phase transition temperatures of the polymerizable liquid crystal compounds L-4 and L-5 were confirmed by texture observation using a polarizing microscope.

The polymerizable liquid crystal compound L-4 changed from a crystalline solid to a liquid crystal phase having a texture specific to a smectic phase at around 109° C. as the temperature was increased. In a case where the temperature was further increased, the phase changed to a nematic phase at 133° C. and transited to an isotropic phase at 154° C. As the phase was cooled from the isotropic phase, it became a nematic phase at around 154° C., became a smectic phase at: around 133° C., and became a crystal at around 109° C., That is, it was found that the polymerizable liquid crystal compound L-4 exhibited a smectic phase at 109° C. to 133° C. and a nematic phase at 133° C. to 154° C. in a case where the temperature was raised and lowered.

The same observation was performed for the polymerizable liquid crystal compound L-5, and it was found that the compound exhibited a nematic phase at 99° C. to 145° C. and had no temperature range exhibiting the smectic phase in a case where the temperature was elevated and lowered.

<Formation of Positive A-plate A-6>

The following composition A-6 was applied onto the photo-alignment film P-2 provided on a temporary support for formation (glass plate) using a spin coater. The coating film formed on the photo-alignment film P-2 was heated to 107° C. with hot air and then cooled to 60° C., and the coating film was irradiated with ultraviolet rays at 100 mJ/cm2 at a wavelength of 365 nm in a nitrogen atmosphere using a high-pressure mercury lamp and subsequently irradiated with ultraviolet rays at 500 mJ/cm2 under heating to 120° C. to fix the alignment of the liquid crystal compound, thereby manufacturing a film A-6 including a positive A-plate A-6. The thickness of the positive A-plate A-6 is shown in Table 3 below. in addition, the weighted average value of I/O values of the liquid crystal compounds in the following composition A-6 is shown in Table 3 below.

In a case where the X-ray diffraction measurement of the positive A-plate A-6 was performed by the same method as in Example 1, a peak exhibiting the same layer structure as the positive A-plate A-1 was observed at 2θ-1.85°.

(Composition A-6)

| | |
|---|---|
| The polymerizable liquid crystal compound L-4 | 42.00 parts by mass |
| The polymerizable liquid crystal compound L-5 | 42.00 parts by mass |
| The following polymerizable liquid crystal compound L-6 | 16.00 parts by mass |
| The polymerization initiator PI-1 | 0.50 parts by mass |
| The leveling agent T-1 | 0.20 parts by mass |
| Methyl ethyl ketone | 235.00 parts by mass |

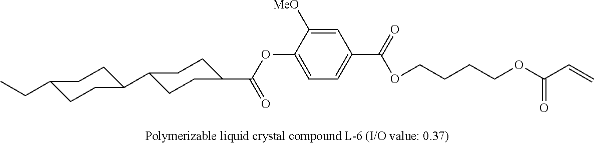 [SMILES: C=CC(=O)OCCCCOC(=O)c1ccc(OC(=O)C2CCC(C3CCC(CC)CC3)CC2)c(OC)c1]

### Comparative Example 4

The following polymerizable liquid crystal compound L-7 was synthesized by the method described in JP2011-207765A.

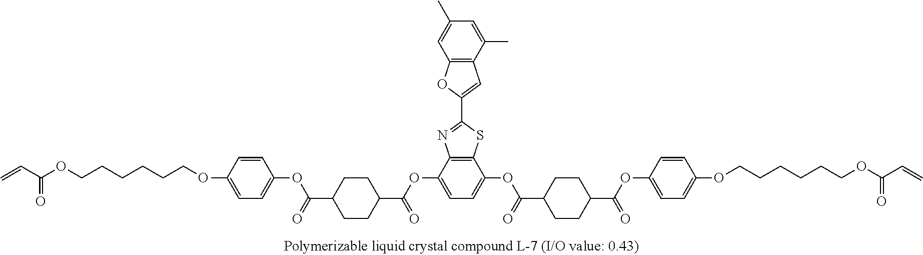 [SMILES: C=CC(=O)OCCCCCCOc1ccc(OC(=O)C2CCC(C(=O)Oc3ccc(OC(=O)C4CCC(C(=O)Oc5ccc(OCCCCCCOC(=O)C=C)cc5)CC4)c4sc(-c5cc6c(C)cc(C)cc6o5)nc34)CC2)cc1]

<Phase Transition Temperature>

Here, the phase transition temperature of the polymerizable liquid crystal compound L-7 was confirmed by texture observation using a polarizing microscope.

The polymerizable liquid crystal compound L-7 exhibited a nematic phase at 153° C. to 200° C. or higher in a case where the temperature was elevated, and was polymerized. In a case where the temperature was lowered, the compound exhibited a nematic phase up to 153° C. and was crystallized.

<Formation of Positive A-plate A-7>

The following composition A-7 was applied onto the photo-alignment film P-2 provided on a temporary support for formation (glass plate) using a spin coater. The coating film formed on the photo-alignment film P-2 was heated to 180° C. with hot air, and then the coating film was irradiated with ultraviolet rays at 500 mJ/cm² in a nitrogen atmosphere while maintaining the temperature at 180° C. to fix the alignment of the liquid crystal compound, thereby manufacturing a glass plate A-7 including a positive A-plate A-7. The thickness of the positive A-plate A-7 is shown in Table 3 below. In addition, the weighted average value of I/O values of the liquid crystal compounds in the following composition A-7 is shown in Table 3 below.

The X-ray diffraction measurement of the positive A-plate A-7 was performed by the same method as in Example 1, and thus, no peak exhibiting the same layer structure as the positive A-plate A-1 was observed.

(Composition A-7)

| | |
|---|---|
| The polymerizable liquid crystal compound L-7 | 100.00 parts by mass |
| The polymerization initiator P1-1 | 0.50 parts by mass |
| The leveling agent T-1 | 0.20 parts by mass |
| Chloroform 5 | 70.00 parts by mass |

### Comparative Example 5

<Synthesis of Liquid Crystal Compound>

The following polymerizable liquid crystal compound L-8 was synthesized according to the method described in paragraphs [0270] to [0272] of JP2014-123134A.

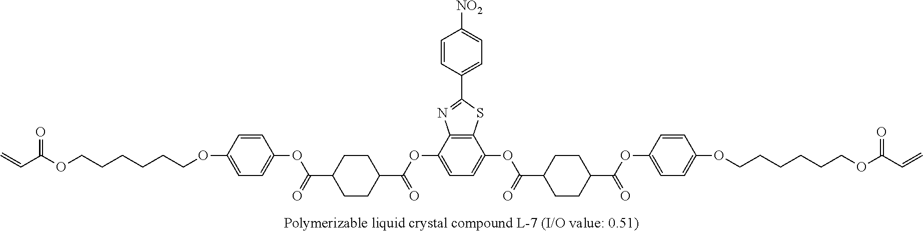 [SMILES: C=CC(=O)OCCCCCCOc1ccc(OC(=O)C2CCC(C(=O)Oc3ccc(OC(=O)C4CCC(C(=O)Oc5ccc(OCCCCCCOC(=O)C=C)cc5)CC4)c4sc(-c5ccc([N+](=O)[O-])cc5)nc34)CC2)cc1]

<Phase Transition Temperature>

Here, the phase transition temperature of the polymerizable liquid crystal compound L-8 was confirmed by texture observation using a polarizing microscope.

The polymerizable liquid crystal compound L-8 exhibits a smectic phase at 160° C. to 169° C., exhibits a nematic phase at 154° C. to 217° C., and exhibits an isotropic phase at 226° C. In a case where the temperature was lowered, the compound exhibited a nematic phase at 217° C. to 113° C. and was crystallized.

<Formation of Positive A-plate A-8>

The following composition A-8 was applied onto the photo-alignment film P-2 provided on a temporary support for formation (glass plate) using a spin coater. The coating film formed on the photo-alignment film P-2 was heated to 210° C. with hot air, and then the coating film was irradiated with ultraviolet rays at 500 mJ/cm² in a nitrogen atmosphere while maintaining the temperature at 190° C. to fix the alignment of the liquid crystal compound, thereby manufacturing a glass plate A-8 including a positive A-plate A-8. The thickness of the positive A-plate A-8 is shown in Table 3 below. In addition, the weighted average value of I/O values of the liquid crystal compounds in the following composition A-8 is shown in Table 3 below.

The X-ray diffraction measurement of the positive A-plate A-8 was performed by the same method as in Example 1, and thus, no peak exhibiting the same layer structure as the positive A-plate A-1 was observed.

(Composition A-8)

| | |
|---|---|
| The polymerizable liquid crystal compound L-8 | 100.00 parts by mass |
| The polymerization initiator PI-1 | 0.50 parts by mass |
| The leveling agent T-1 | 0.20 parts by mass |
| Chloroform | 570.00 parts by mass |

<Reference Example>

Furthermore, the composition A-8 was applied onto the photo-alignment film P-3 provided on a temporary support for formation (glass plate) using a spin coater, and the coating film was heated to 80° C. with hot air, and then the coating film was irradiated with ultraviolet rays at 500 mJ/cm² in a nitrogen atmosphere while maintaining the temperature at 165° C. to fix the alignment of the liquid crystal compound, but the entire surface was deteriorated and the coating film was cloudy. In the X-ray diffraction measurement for this coating film, a peak exhibiting a layer structure was observed at 2θ-2.00°.

[Manufacture of Polarizing Plate]

<Formation of Positive C-plate C-1>

A film C-1 having a positive C-plate C-1 on a temporary support for formation was manufactured by the same method as for the positive C-plate described in paragraph [0124] of JP2015-200861A. It should be noted that the thickness of the positive C-plate was controlled so that Rth(550) was −69 nm.

<Formation of Polarizing Plate>

A surface of a TD80UL (manufactured by FUJIFILM Corporation) which is a support was subjected to an alkali saponification treatment. Specifically, the support was immersed in a 1.5 N aqueous sodium hydroxide solution at 55° C. for 2 minutes, and the extracted support was washed in a water-washing bathtub at room temperature and neutralized with 0.1 N sulfuric acid at 30° C. Thereafter, the obtained support was washed in a water-washing bathtub at room temperature and further dried with a hot air at 100° C.

Subsequently, a roll-shaped polyvinyl alcohol film having a. thickness of 80 μm was continuously stretched five times in an iodine aqueous solution, and the stretched film was dried to obtain a polarizer having a thickness of 20 μm.

The obtained polarizer was bonded to a support (TD80UL) which had been subjected to an alkali saponification treatment were bonded to each other to obtain a polarizing plate 0 in which the polarizer was exposed on one side.

Next, the polarizer of the polarizing plate 0 and the coated surface of the positive A-plate were bonded to each other using a pressure-sensitive adhesive (SK-2057, manufactured by Soken Chemical Co., Ltd.) so that the absorption axis of the polarizer and the slow axis of each of the positive A-plates A-1 to 8 manufactured in Examples 1 to 3 and Comparative Examples 1 to 5 were perpendicular to each other, and subsequently, the polarizing plate was peeled from the film or the glass plate to transfer only the positive A-plate onto the polarizing plate. Subsequently, the coated surface of the positive C-plate in the film C-1 was bonded onto the surface of the transferred positive A-plate using a pressure-sensitive adhesive (SK-2057, manufactured by Soken Chemical Co., Ltd.), and the support of the film C-1 was peeled to transfer only the positive C-plate C-1 onto the positive A-plates A-1 to 8, thereby manufacturing polarizing plates 1 to 8.

[Manufacture of Liquid Crystal Display Device]

A polarizing plate on the visible side was peeled from a liquid crystal cell of iPad (registered trademark, manufactured by Apple) and used as an IPS-mode liquid crystal cell. Each of the polarizing plates 1 to 8 manufactured above instead of the peeled polarizing plate was as bonded onto the liquid crystal cell to manufacture a liquid crystal display device. At this time, the bonding was performed such that the absorption axis of the polarizing plate and the optical axis of the liquid crystal layer in the liquid crystal cell were perpendicular to each other as observed from a direction vertical to the substrate surface of the liquid crystal cell at the time of a voltage being off.

[Evaluation]

For the measurement of the display performance, a commercially available measuring apparatus for a liquid crystal viewing angle and chromaticity characteristics, Ezcontrast (manufactured by ELDIM), was used, and for the backlight, a commercially available liquid crystal display device iPad (registered trademark, manufactured by Apple) was used. The liquid crystal cell to which the polarizing plate had been bonded was placed so that the optically anisotropic layer was on the side opposite to the backlight side, and measured.

<Measurement of Optical Characteristics>

The light incidence angle dependence of Re was measured at wavelengths of 450 nm and 550 nm, using AxoScan OPMF-1 (manufactured by Opto Science, Inc.). The results are shown in Table 3 below.

<Contrast>

In order to set a standard for evaluation, a polarizing plate 0 in which the positive A-plate and the positive C-plate had not been bonded to each other was directly bonded to a liquid crystal display device.

A luminance (Yw) in the direction vertical to a panel in a white display and a luminance (Yb) in the direction vertical to a panel in a black display were measured using a commercially available measuring apparatus for a liquid crystal viewing angle and chromaticity characteristics, Ezcontrast (manufactured by ELDIM), and a contrast ratio (Yw/Yb) in the direction vertical to the panel was calculated and taken as a front contrast, and evaluated according to the following standard. The results are shown in Table 3 below.

A: The front contrast is 95% or more with respect to the polarizing plate 0.

B: The front contrast is 85% or more and less than 95% with respect to polarizing plate 0.

C: The front contrast is 75% or more and less than 85% with respect to polarizing plate 0.

D: The front contrast is less than 75% with respect to polarizing plate 0.

<Moisture-Heat Resistance>

Glass was further bonded onto the polarizing plate bonded to the liquid crystal display device, using a pressure-sensitive adhesive, and after being left at 500 hours at 85° C., it was compared with the same sample which had not been exposed to a high temperature to evaluate a tint change during black display. The results are shown in Table 3 below.

A: A tint change is not visually recognized for a sample which has not been exposed to a high temperature.

B: A tint change within an acceptable range is perceived for a sample which has not been exposed to a high temperature.

C: A tint change is significant and not acceptable for a sample which has not been exposed to a high temperature.

TABLE 3

| | | Optically anisotropic film | | | | | | | | | |
|---|---|---|---|---|---|---|---|---|---|---|---|
| | | Poly- | | | Weighted | | | | | | |
| | | merizable | | | average | | Photo- | Evaluation | | | |
| | | liquid | Phase | Thick- | value | | align- | | | | Moisture- |
| | Polarizing | crystal | transition | ness | of I/O | Layer | ment | Re550 | Re450/ | | heat |
| | plate | compound | temperature | (μm) | values | structure | film | (nm) | Re550 | Contrast | durability |
| Example 1 | Polarizing | L-1 | C 136 S 198 N > 250 I | 2.4 | 0.50 | Present | P-1 | 144 | 0.86 | A | A |
| | plate 1 | L-2 | C 143 N 208 > 250 I | | | | | | | | |
| Example 2 | Polarizing | L-1 | C 136 S 198 N > 250 I | 2.4 | 0.50 | Present | P-2 | 144 | 0.86 | A | A |
| | plate 2 | L-2 | C 143 N 208 I | | | | | | | | |
| Comparative | Polarizing | L-1 | C 136 S 198 N > 250 I | 2.4 | 0.50 | Present | P-3 | 144 | 0.86 | C | A |
| Example 1 | plate 3 | L-2 | C 143 N 208 I | | | | | | | | |
| Comparative | Polarizing | L-1 | C 136 S 198 N > 250 I | 2.5 | 0.50 | Absent | P-2 | 144 | 0.86 | D | A |
| Example 2 | plate 4 | L-2 | C 143 N 208 1 | | | | | | | | |
| Example 3 | Polarizing | L-1 | C 136 S 198 N > 250 I | 2.1 | 0.51 | Present | P-2 | 144 | 0.86 | A | B |
| | plate 5 | | | | | | | | | | |
| Comparative | Polarizing | L-4 | C 109 S 133 N 154 I | 2.5 | 0.58 | Present | P-2 | 144 | 0.86 | A | C |
| Example 3 | plate 6 | L-5 | C 99 N 145 I | | | | | | | | |
| Comparative | Polarizing | L-7 | C 153 N > 200 I | 2.6 | 0.43 | Absent | P-3 | 144 | 0.82 | D | A |
| Example 4 | plate 7 | | | | | | | | | | |
| Comparative | Polarizing | L-8 | C 160 S 169 N 224 I | 2.1 | 0.51 | Absent | P-3 | 144 | 0.84 | D | B |
| Example 5 | plate 8 | | ※ 1 | | | | | | | | |

※ 1: Exhibiting a smectic phase in the cooling step, but being stabilized at the 154° C.

From the results shown in Table 3 above, it was found that in a case where the rubbing alignment film was used instead of the photo-alignment film, the film contrast of an optical film thus formed was deteriorated (Comparative Example 1).

Furthermore, it was found that in a case where an optically anisotropic film exhibiting no diffraction peak derived from a periodic structure in the X-ray diffraction measurement is included, the film contrast of an optical film thus formed was deteriorated (Comparative Example 2).

In addition, it was found that in a case where a polymerizable liquid crystal compound not corresponding to the polymerizable liquid crystal compound (1) is used, any one of the film contrast or the moisture-heat resistance of an optical film thus formed is deteriorated (Comparative Examples 3 to 5).

In contrast, it was found that in a case where an optically anisotropic film formed using a polymerizable liquid crystal composition containing the polymerizable liquid crystal compound (1), satisfying Formula (I) or (II), and exhibiting a diffraction peak derived from a periodic structure in the X-ray diffraction measurement is used, the film contrast of the optical film is excellent and the moisture-heat resistance is also improved (Examples 1 to 3).

In particular, from the comparison of Examples 1 to 3, it was found that in a case where the polymerizable liquid crystal compound (2) is blended, the moisture-heat resistance of the optical film is improved.

### Example 4

[Manufacture of Cellulose Acylate Film1]

<Manufacture of Core Layer Cellulose Acylate Dope>

The following composition was put into a mixing tank and stirred to dissolve the respective components to prepare a cellulose acetate solution for use as a core layer cellulose acylate dope.

Core layer cellulose acylate dope

| | |
|---|---|
| Cellulose acetate having a degree of acetyl substitution of 2.88 | 100 parts by mass |
| Polyester compound B described in Examples of JP2015-227955A | 12 parts by mass |
| The following compound F | 2 parts by mass |
| Methylene chloride (first solvent) | 500 parts by mass |
| Methanol (second solvent) | 75 parts by mass |

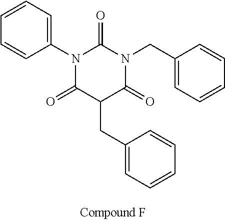 [SMILES: O=C1C(Cc2ccccc2)C(=O)N(c2ccccc2)C(=O)N1Cc1ccccc1]

<Manufacture of Outer Layer Cellulose Acylate Dope>

10 parts by mass of the following matting agent solution was added to 90 parts by mass of the core layer cellulose acylate dope to prepare a cellulose acetate solution for use as an outer layer cellulose acylate dope.

Matting agent solution

| | |
|---|---|
| Silica particles with an average particle size | 2 parts by mass |
| of 20 mn (AEROSIL R972, manufactured | |
| by Nippon Acrosit Co., Ltd.) | |
| Methylene chloride (first solvent) | 76 parts by mass |
| Methanol (second solvent) | 11 parts by mass |
| The core layer cellulose acylate dope | 1 part by mass |

<Film Formation for Cellulose Acylate Film 1>

The core layer cellulose acylate dope and the outer layer cellulose acylate dope were filtered through a filter paper having an average pore diameter of 34 μm and a sintered metal filter having an average pore diameter of 10 μm, and then all the three layers of the core layer cellulose acylate dope and the outer layer cellulose acylate dopes on both sides thereof were simultaneously cast on a metal drum at 20° C. from a casting port (band caster)

After casting, the formed film was peeled from the metal hand in a state where the solvent content was approximately 20% by mass, and the both ends of the film in the width direction were fixed with a tenter clip and dried while stretching the film at a stretch ratio of 1.1 times in the transverse direction. Thereafter, by transporting the film between rolls of a heat treatment device, the film was further dried and rolled to manufacture a long cellulose acylate film 1 having a thickness of 20 μm. The core layer of the film had a thickness of 16 μm, and the outer layers arranged on both sides of the core layer each had a thickness of 2 μm. The in-plane retardation of the obtained cellulose acylate film 1 was 0 nm.

[Manufacture of Photo-Alignment Film P-4]

A photo-alignment film P-4 was formed in the same manner as in the manufacture of the photo-alignment film P-1, except that the cellulose acylate film 1 was used as the temporary support for formation.

[Formation of Positive A-Plate A-9]

A film A-9 including a positive A-plate A-9 was manufactured by the same method as in Example 1, except that the following composition A-9 prepared in advance was applied onto the photo-alignment film P-4.

X-ray diffraction measurement for the positive A-plate A-9 was performed by the same method as in Example 1, and thus, a peak having the same layer constitution as that of the positive A-1 plate A-1 was observed. In addition, there was little visible defects in the surface condition in the long film, and manufacture in a wide and long dimension was easy.

(Composition A-9)

| | |
|---|---|
| The following polymerizable liquid crystal compound L-1 | 40 parts by mass |
| The following polymerizable liquid crystal compound L-2 | 20 parts by mass |
| The following polymerizable liquid crystal compound L-9 | 40 parts by mass |
| The following polymerization initiator PI -1 | 0.50 parts by mass |
| The leveling agent T-1 | 0.20 parts by mass |
| Cyclopentanone | 235.00 parts by mass |

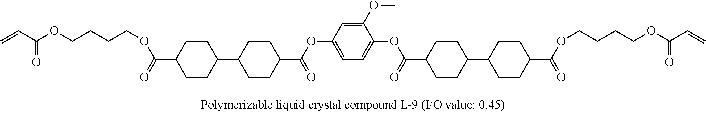 [SMILES: C=CC(=O)OCCCCOC(=O)C1CCC(C2CCC(C(=O)Oc3ccc(OC(=O)C4CCC(C5CCC(C(=O)OCCCCOC(=O)C=C)CC5)CC4)c(OC)c3)CC2)CC1]

### Example 5

[Formation of Positive A-Plate A-10]

A film A-10 including a positive A-plate A-10 was manufactured by the same method as in Example 4, except that the following composition was used.

X-ray diffraction measurement for the positive A-plate A-10 was performed by the same method as in Example 1, and thus, a peak having the same layer constitution as that of the positive A-1 plate A-1 was observed. In addition, there was little visible defects in the surface condition in the long film, and creation in a wide and long dimension was easy.

(Composition A-10)

| | |
|---|---|
| The following polymerizable liquid crystal compound L-1 | 40.00 parts by mass |
| The following polymerizable liquid crystal compound L-2 | 20.00 parts by mass |
| The following polymerizablc liquid crystal compound L-10 | 40.00 parts by mass |
| The following polymerization initiator PI-1 | 0.50 parts by mass |
| The leveling agent T-1 | 0.20 parts by mass |
| Cyclopentanone | 235.00 parts by mass |

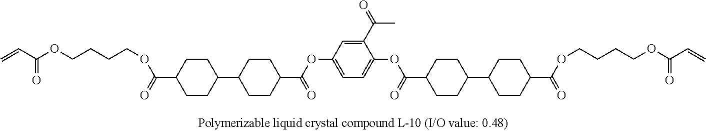 [SMILES: C=CC(=O)OCCCCOC(=O)C1CCC(C2CCC(C(=O)Oc3ccc(OC(=O)C4CCC(C5CCC(C(=O)OCCCCOC(=O)C=C)CC5)CC4)c(C(C)=O)c3)CC2)CC1]

A polarizing plate and an image display device were manufactured by the same method as in Example 1, using the film A-9 including the positive A-plate A-9 manufactured in Example 4 and the film A-10 including the positive A-plate A-10 manufactured in Example 5, and optical characteristics and the like were evaluated by the same method as in Example 1. The evaluation results are shown in Table 4 below.

Incidentally, in Table 4 below, the evaluation results (A) for the surface condition are evaluation results showing that neither bright spots or streak-like defects were observed in the case of confirming the surface conditions of the film A-9 and the film A-10 with a polarizing microscope and visual observation.

TABLE 4

| | | Optically anisotropic film | | | | | | | | | | |
|---|---|---|---|---|---|---|---|---|---|---|---|---|
| | | Poly- | | | Weighted | | | | | | | |
| | | merizable | | | average | | Photo- | Evaluation | | | | |
| | | liquid | Phase | Thick- | value | | align- | | | | Moisture- | |
| | Polarizing | crystal | transition | ness | of I/O | Layer | ment | Re550 | Re450/ | Con- | heat | Surface |
| | plate | compound | temperature | (μm) | values | structure | film | (nm) | Re550 | trast | durability | condition |
| Example 4 | Polarizing | L-1 | C 136 S 198 N > 250 I | 2.8 | 0.48 | Present | P-4 | 144 | 0.86 | A | A | A |
| | plate 9 | L-2 | C 143 N 208 I | | | | | | | | | |
| | | L-9 | C 125 S 168 N 254 I | | | | | | | | | |
| Example 5 | Polarizing | L-1 | C 136 S 198 N > 250 I | 2.8 | 0.50 | Present | P-4 | 144 | 0.86 | A | A | A |
| | plate 10 | L-2 | C 143 N 208 I | | | | | | | | | |
| | | L-10 | C 84 S 131 N > 250 I | | | | | | | | | |

From the results shown in Table 3 above, it was found that in a case where a polymerizable liquid crystal composition containing the polymerizable liquid crystal compound (3) is used together with the polymerizable liquid crystal compounds (1) and (2), the film contrast of the optical film is excellent and the moisture-heat resistance is also improved, and in addition, an optically anisotropic film with less failure in the surface condition can be obtained even with a wide and long film (Examples 4 and 5).

### EXPLANATION OF REFERENCES

10: optical film

12: optically anisotropic film

14: photo-alignment film

16: support

18: hard coat layer

What is claimed is:

1. An optical film comprising:
an optically anisotropic film obtained by polymerizing a polymerizable liquid crystal composition; and
a photo-alignment film,
wherein the polymerizable liquid crystal composition contains a polymerizable liquid crystal compound represented by Formula (1), and
the optically anisotropic film satisfies Formula (I) or (II) and exhibits a diffraction peak derived from a periodic structure in X-ray diffraction measurement,
L¹-SP¹-E¹-Cy²-Cy¹-D¹-Ar¹-D²-Cy³-Cy⁴-E²-SP²-L² (1)
Re(450)/Re(550)<1 (I)
Rth(450)/Rth(550)<1 (II)
in Formula (1), D¹, D², E¹, and E² each independently represent a single bond, —CO—O—, —C(═S)O—, —CR¹R²—, —CR¹R²—CR³R⁴—, —O—CR¹R²—, —CR¹R²—O—CR³R⁴—, —CO—O—CR¹R²—, —O—CO—CR¹R²—, —CR¹R²—O—CO—CR³R⁴—, —CR¹R²—CO—O—CR³R⁴—, —NR¹—CR²R³, or —CO—NR¹—, where R¹, R², R³, and R⁴ each independently represent a hydrogen atom, a fluorine atom, or an alkyl group having 1 to 4 carbon atoms,
Cy¹, Cy², Cy³, and Cy⁴ each independently represent a 1,4-cyclohexylene group which may have a substituent,
SP¹ and SP² each independently represent a single bond, a linear or branched alkylene group having 1 to 12 carbon atoms, or a divalent linking group in which one or more of —CH₂—'s constituting the linear or branched alkylene group having 1 to 12 carbon atoms are substituted with —O—, —S—, —NH—, —N(Q)-, or —CO—, and Q represents a substituent,
L¹ and L² each independently represent a monovalent organic group, and at least one of L¹ or L² represents a polymerizable group, and
Ar¹ represents an aromatic ring which is selected from the group consisting of groups represented by Formulae (Ar-1) to (Ar-4) and satisfies any one of the following conditions 1 to 3, 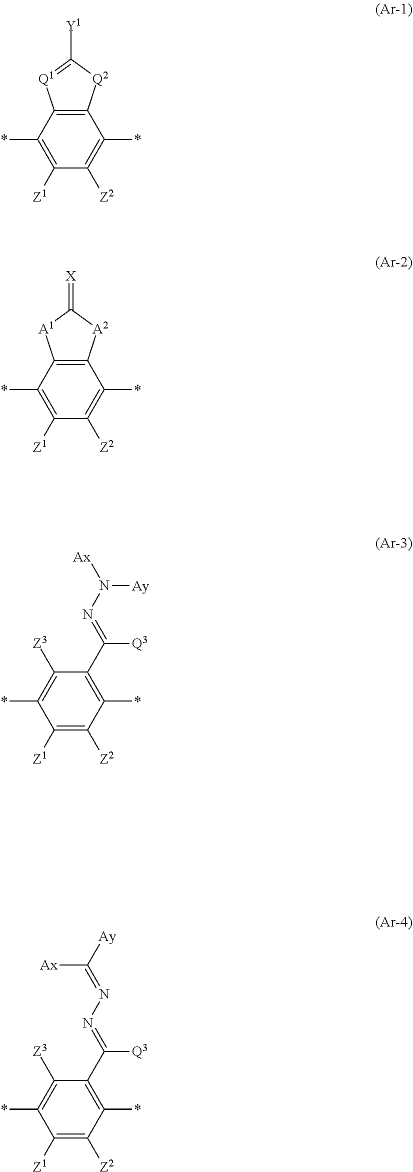
in Formulae (Ar-1) to (Ar-4), * represents a bonding position to D¹ or D²,
Q¹ represents N or CH,
Q² represents —S—, —O—, or —N(R⁵)—, where R⁵ represents a hydrogen atom or an alkyl group having 1 to 6 carbon atoms,
Y¹ represents an aromatic hydrocarbon group having 6 to 12 carbon atoms or an aromatic heterocyclic group having 3 to 12 carbon atoms, which may have a substituent,
Z¹, Z², and Z³ each independently represent a hydrogen atom, a monovalent aliphatic hydrocarbon group having 1 to 20 carbon atoms, a monovalent alicyclic hydrocarbon group having 3 to 20 carbon atoms, a monovalent aromatic hydrocarbon group having 6 to 20 carbon atoms, a halogen atom, a cyano group, a nitro group, —OR⁶, —NR⁷R⁸, or —SR⁹, R⁶ to R⁹ each independently represent a hydrogen atom or an alkyl group having 1 to 6 carbon atoms, and Z¹ and Z² may be bonded to each other to form an aromatic ring,
A¹ and A² each independently represent a group selected from the group consisting of —O—, —N(R¹⁰)—, —S—, and —CO—, where R¹⁰ represents a hydrogen atom or a substituent,
X represents a hydrogen atom or a non-metal atom of Groups XIV to XVI to which a substituent may he bonded,
Ax represents an organic group having 2 to 30 carbon atoms, which has at least one aromatic ring selected from the group consisting of an aromatic hydrocarbon ring and an aromatic heterocyclic ring,
Ay represents a hydrogen atom, an alkyl group having 1 to 12 carbon atoms, which may have a substituent, or an organic group having 2 to 30 carbon atoms, which has at least one aromatic ring selected from the group consisting of an aromatic hydrocarbon ring and an aromatic heterocyclic ring,
the aromatic ring in each of Ax and Ay may have a substituent, and Ax and Ay may be bonded to each other to form a ring, and
In addition, Q³ represents a hydrogen atom, or an alkyl group having 1 to 6 carbon atoms, which may have a substituent.
Condition 1: in a case where Ar¹ is represented by Formula (Ar-1), both of Z¹ and Z² represent a group having a van der Waals volume of less than 0.3×10² Å³, and a substituent which may be contained in Y¹ represent a substituent having a van der Waals volume of less than 0.3×10² Å³,
Condition 2: in a case where Ar¹ is represented by Formula (Ar-2), both of Z¹ and Z² represent a group having a van der Waals volume of less than 0.3×10² Å³, and a substituent which may he contained in X represent a substituent having a van der Waals volume of less than 0.3×10² Å³, and
Condition 3: in a case where Ar¹ is represented by Formula (Ar-3) or (Ar-4), Z¹, Z², and Z³ each represent a group having a van der Waals volume of less than 0.3×10² Å³,
in Formula (I), Re(450) represents an in-plane retardation of the optically anisotropic film at a wavelength of 450 nm, and Re(550) represents an in-plane retardation of the optically anisotropic film at a wavelength of 550 nm, and
in Formula (II), Rth(450) represents a thickness-direction retardation of the optically anisotropic film at a wavelength of 450 nm, and Rth(550) represents a thickness-direction retardation of the optically anisotropic film at a wavelength of 550 nm.

2. The optical film according to claim 1,
wherein the polymerizable liquid crystal composition further contains a polymerizable liquid crystal compound represented by Formula (2),
L¹-SP¹-E¹-Cy²-Cy¹-D¹-Ar²-D²-Cy³-Cy⁴-E²-SP²-L² (2)
in Formula (2), D¹, D², E¹, and E² each independently represent a single bond, —CO—O—, —C(═S)O—, —CR¹R²—, —CR¹R²—CR³R⁴—, —O—CR¹R²—, —CR¹R²—O—CR³R⁴—, —CO—O—CR¹R²—, —O—CO—CR¹R²—, —CR¹R²—O—CO—CR³R⁴—, —CR¹R²—CO—O—CR³R⁴—, —NR¹—CR²R³, or —CO—NR¹—, where R¹, R², R³, and R⁴ each independently represent a hydrogen atom, a fluorine atom, or an alkyl group having 1 to 4 carbon atoms,
Cy¹, Cy², Cy³, and Cy⁴ each independently represent a 1,4-cyclohexylene group which may have a substituent,
SP¹ and SP² each independently represent a single bond, a linear or branched alkylene group having 1 to 12 carbon atoms, or a divalent linking group in which one or more of —CH₂—'s constituting the linear or branched alkylene group having 1 to 12 carbon atoms are substituted with —O—, —S—, —NH—, —N(Q)—, or —CO—, and Q represents a substituent,
L¹ and L² each independently represent a monovalent organic group, and at least one of L¹ or L² represents a polymerizable group, provided that in a case where Ar² is an aromatic ring represented by Formula (Ar-3), at least one of L¹ or L², or L³ or L⁴ in Formula (Ar-3) represents a polymerizable group, and
Ar² represents an aromatic ring which is selected from the group consisting of groups represented by Formulae (Ar-1) to (Ar-5) and satisfies any one of the following conditions 4 to 7, 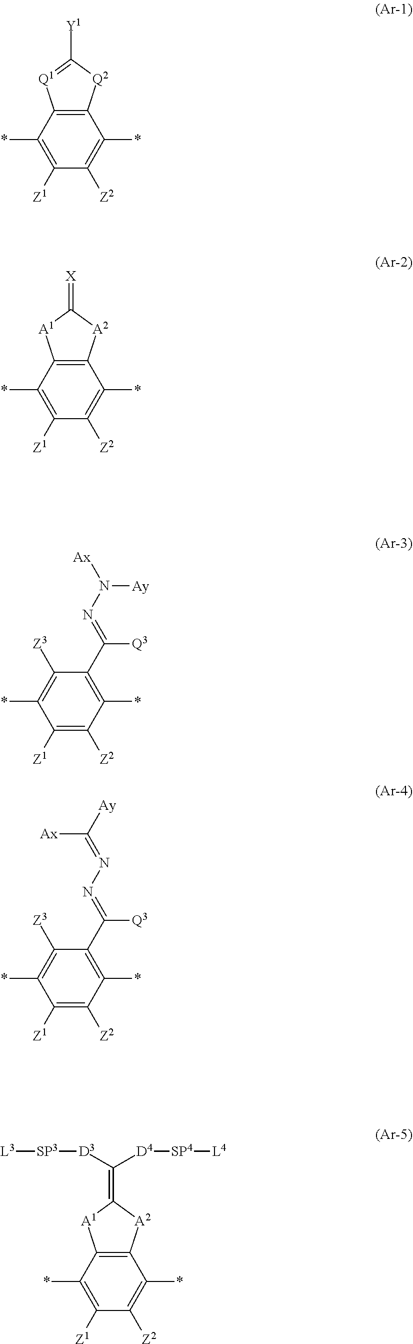
in Formulae Ar-1) to (Ar-5), * represents a bonding position to D¹ or D²,
Q¹ represents N or CH,
Q² represents —S—, —O—, or —N(R⁵)—, where R⁵ represents a hydrogen atom or an alkyl group having 1 to 6 carbon atoms,
Y¹ represents an aromatic hydrocarbon group having 6 to 12 carbon atoms or an aromatic heterocyclic group having 3 to 12 carbon atoms, which may have a substituent,
Z¹, Z², and Z³ each independently represent a hydrogen atom, a monovalent aliphatic hydrocarbon group having 1 to 20 carbon atoms, a monovalent alicyclic hydrocarbon group having 3 to 20 carbon atoms, a monovalent aromatic hydrocarbon group having 6 to 20 carbon atoms, a halogen atom, a cyano group, a nitro group, —OR⁶, —NR⁷R⁸, or —SR⁹, R⁶ to R⁹ each independently represent a hydrogen atom or an alkyl group having 1 to 6 carbon atoms, and Z¹ and Z² may be bonded to each other to form an aromatic ring,
A¹ and A² each independently represent a group selected from the group consisting of —O—, —N(R¹⁰)—, —S—, and —CO—, where R¹⁰ represents a hydrogen atom or a substituent,
X represents a hydrogen atom or a non-metal atom of Groups XIV to XVI to which a substituent may be bonded,
D³ and D⁴ each independently represent a single bond, —CO—O—, —C(═S)O—, —CR¹R²—, —CR¹R²—CR³R⁴—, —O—CR¹R²—, —CR¹R²—O—CR³R⁴—, —CO—O—CR¹R²—, —O—CO—CR¹R²—, —CR¹R²—O—CO—CR³R⁴—, —CR¹R²—CO—O—CR³R⁴—, —NR¹—CR²R³, or —CO—NR¹—, R¹, R², R³, and R⁴ each independently represent a hydrogen atom, a fluorine atom, or an alkyl group having 1 to 4 carbon atoms.
SP³ and SP⁴ each independently represent a single bond, a linear or branched alkylene group having 1 to 12 carbon atoms, or a divalent linking group in which one or more of —CH₂—'s constituting the linear or branched alkylene group having 1 to 12 carbon atoms are substituted with —O—, —S—, —NH—, —N(Q)—, or —CO—, and Q represents a substituent,
L³ and L⁴ each independently represent a monovalent organic group, and at least one of L³ or L⁴, or L¹ or L² in Formula (2) represents a polymerizable group,
Ax represents an organic group having 2 to 30 carbon atoms, which has at least one aromatic ring selected from the group consisting of an aromatic hydrocarbon ring and an aromatic heterocyclic ring,
Ay represents a hydrogen atom, an alkyl group having 1 to 12 carbon atoms, which may have a substituent, or an organic group having 2 to 30 carbon atoms, which has at least one aromatic ring selected from the group consisting of an aromatic hydrocarbon ring and an aromatic heterocyclic ring,
the aromatic ring in each of Ax and Ay may have a substituent, and Ax and Ay may be bonded to each other to form a ring, and
In addition, Q³ represents a hydrogen atom, or an alkyl group having 1 to 6 carbon atoms, which may have a substituent.
Condition 4: in a case where Ar² is represented by Formula (Ar-1), the substituent which may be contained in any one or more of Z¹, Z², or Y¹ represents a group having a van der Waals volume of 0.3×10² Å³ or more,
Condition 5: in a case where Ar² is represented by Formula (Ar-2), the substituent which may be contained in any one or more of Z¹, Z², or X represents a group having a van der Wants volume of 0.3×10² Å³ or more,
Condition 6: in a case where Ar² is represented by Formula (Ar-3) or (Ar-4), the substituent which may be contained in any one or more of Z¹, Z², or Z³ represents a group having a van der Waals volume of 0.3×10² Å³ or more, and
Condition 7: in a case where Ar² is represented by Formula (Ar-5), at least one of a group represented by -D3-SP3-L3 or a group represented by -D4-SP4-L4 represents a group having a van der Waals volume of 0.3×10² Å³ or more.

3. The optical film according to claim 1,
wherein Ar¹ in Formula (1) is represented by Formula (Ar-2).

4. The optical film according to claim 1,
wherein the liquid crystal compound contained in the polymerizable liquid crystal composition has an I/O value of 0.51 or less as a weighted average value.

5. The optical film according to claim 1,
wherein the polymerizable liquid crystal composition further contains a polymerizable compound not corresponding to any of the polymerizable liquid crystal compound represented by Formula (1) according to claim 1 and the polymerizable liquid crystal compound represented by Formula (2) according to claim 2, and having two or more polymerizable groups.

6. The optical film according to claim 1,
wherein the polymerizable liquid crystal composition contains a polymerization initiator.

7. The optical film according to claim 6,
wherein the polymerization initiator is an oxime-type polymerization initiator.

8. A polarizing plate comprising:
the optical film according to claim 1; and
a polarizer.

9. An image display device comprising:
the optical film according to claim 1.

10. An image display device comprising:
the polarizing plate according to claim 8.

11. The optical film according to claim 2,
wherein Ar¹ in Formula (1) is represented by Formula (Ar-2).

12. The optical film according to claim 2,
wherein the liquid crystal compound contained in the polymerizable liquid crystal composition has an I/O value of 0.51 or less as a weighted average value.

13. The optical film according to claim 2,
wherein the polymerizable liquid crystal composition further contains polymerizable compound not corresponding to any of the polymerizable liquid crystal compound represented by Formula (1) according to claim 1 and the polymerizable liquid crystal compound represented by Formula (2) according to claim 2, and having two or more polymerizable groups.

14. The optical film according to claim 2,
wherein the polymerizable liquid crystal composition contains a polymerization initiator.

15. The optical film according to claim 14,
wherein the polymerization initiator is an oxime-type polymerization initiator.

16. A polarizing plate comprising:
the optical film according to claim 2; and
a polarizer.

17. An image display device comprising:
the optical film according to claim 2.

18. An image display device comprising:
the polarizing plate according to claim 16.

19. The optical film according to claim 3,
wherein the liquid crystal compound contained in the polymerizable liquid crystal composition has an I/O value of 0.51 or less as a weighted average value.

20. The optical film according to claim 3,
wherein the polymerizable liquid crystal composition further contains a polymerizable compound not corresponding to any of the polymerizable liquid crystal compound represented by Formula (1) according to claim 1 and the polymerizable liquid crystal compound represented by Formula (2) according to claim 2, and having two or more polymerizable groups.
